(19) United States
(12) Patent Application Publication
(10) Pub. No.: US 2024/0255956 A1
(43) Pub. Date: Aug. 1, 2024

(54) INFORMATION PROCESSING DEVICE, INFORMATION PROCESSING SYSTEM, INFORMATION PROCESSING METHOD, AND PROGRAM

(71) Applicant: SONY GROUP CORPORATION, TOKYO (JP)

(72) Inventor: HIROSHI MIYAGAWA, TOKYO (JP)

(21) Appl. No.: 18/562,352

(22) PCT Filed: Jan. 27, 2022
(86) PCT No.: PCT/JP2022/003020

§ 371 Date: Nov. 20, 2023

(30) Foreign Application Priority Data
Jun. 8, 2021 (JP) 2021-095647

(51) Int. Cl. G05D 1/622; G05D 1/246

(52) U.S. Cl. CPC G05D 1/622; G05D 1/246

(57) ABSTRACT

There are provided a device and a method that can quickly correct an approach area defined as a work area of a robot when a new obstacle that is not on a predefined map occurs. There are provided a differential obstacle detector that detects a differential obstacle corresponding to a difference from an obstacle recorded on a predefined map on the basis of information from a sensor that acquires travel environment information of the robot, and an approach area corrector that corrects, in consideration of the differential obstacle, a preset approach area in which a work by the robot is determined to be executable without contact with the obstacle, and generates a corrected approach area, the preset approach area including an area recorded on the predefined map. The approach area corrector determines whether or not a sampling point set inside the preset approach area allows the robot to work without contacting the differential obstacle, and generates the corrected approach area.

### TECHNICAL FIELD

The present disclosure relates to an information processing device, an information processing system, an information processing method, and a program. Specifically, the present disclosure relates to an information processing device, an information processing system, an information processing method, and a program that perform control for causing a robot to execute a predetermined motion.

### BACKGROUND ART

In recent years, the use of robots has increased in various fields.

For example, in factories, robots perform most of the work that has been conventionally performed by humans.

There are various types of processing performed by a robot, and as an example, there is a configuration in which movement and work are repeatedly performed, such as performing a work a at a certain work location A, then moving to the next work location B, and performing a work b at the work location B.

For example, the work is a work of picking up a load at the work location A, moving to the work location B, and unloading the load.

Note that there is a mobile manipulator as a robot in which a manipulator including a hand and an arm for work is mounted on a moving body.

Movement of the moving body allows the mobile manipulator to perform work in various work areas.

In a case where the robot performs work at each work location while moving between a plurality of work locations, it is necessary to confirm the locations of the robot at which a scheduled work can be performed at each of the work locations A and B in advance, and furthermore, to define a path for safely moving between these work locations.

For example, if a moving unit of the mobile manipulator cannot move forward due to an obstacle and the hand cannot reach a work target object, the scheduled work cannot be performed.

In order to calculate a location that allows the robot to work at each work location, it is necessary to perform location calculation processing using inverse kinematics for obtaining a location where the moving unit can reach an object to be a work target, and calculation processing for determining interference (contact) with an obstacle such as a desk, and the amount of calculation for the above processing is enormous. It is therefore difficult to calculate a movement path and a location that allows work in real time while the robot is moving.

An example of a conventional technique that discloses a method of solving such problems is Patent Document 1 (Japanese Patent No. 6641804). Patent Document 1 discloses a configuration in which before start of work by a robot, a work allowable area for an object to be worked on is calculated for each work location where the robot performs work, and the robot is moved to each work allowable area to execute the work.

However, the method in Patent Document 1 has a problem that in a case where a new obstacle is placed in a work allowable area calculated in advance, the robot cannot be moved to the previously created work allowable area, and a scheduled work cannot be performed.

### CITATION LIST

### Patent Document

Patent Document 1: Japanese Patent No. 6641804

### SUMMARY OF THE INVENTION

### Problems to be Solved by the Invention

The present disclosure has been made in view of the above problems, for example, and an object of the present disclosure is to provide an information processing device, an information processing system, an information processing method, and a program capable of efficiently creating a new work allowable area in consideration of an obstacle and causing a robot to perform a scheduled work even in a case where a new obstacle is placed in a calculated work allowable area calculated in advance.

### Solutions to Problems

A first aspect of the present disclosure is
an information processing device including
a differential obstacle detector that detects a differential obstacle corresponding to a difference from an obstacle recorded on a predefined map on the basis of information from a sensor that acquires travel environment information of the robot, and
an approach area corrector that corrects, in consideration of the differential obstacle, a preset approach area in which a work by the robot is determined to be executable without contact with the obstacle, and generates a corrected approach area, the preset approach area including an area recorded on the predefined map, in which
the approach area corrector determines whether or not a sampling point set inside the preset approach area allows the robot to work without contacting the differential obstacle, and generates the corrected approach area.

Furthermore, a second aspect of the present disclosure is
an information processing system including a user terminal, and an information processing device attached to a robot, in which
the user terminal generates a predefined map including a location of an obstacle in a travel environment of the robot and a preset approach area in which a work by the robot is determined to be executable without contact with the obstacle, and inputs the predefined map to the information processing device attached to the robot,
the information processing device attached to the robot includes
a differential obstacle detector that detects a differential obstacle corresponding to a difference from the obstacle recorded in the predefined map input from the user terminal on the basis of information from a sensor that acquires travel environment information of the robot, and
an approach area corrector that corrects, in consideration of the differential obstacle, a preset approach area in which the work by the robot is determined to be executable without contact with the obstacle, and generates a corrected approach area, the preset approach area including an area recorded in the predefined map, and
the approach area corrector determines whether or not a sampling point set inside the preset approach area allows the robot to work without contacting the differential obstacle, and generates the corrected approach area.

Furthermore, a third aspect of the present disclosure is
an information processing method executed in an information processing device, the method including
a differential obstacle detecting step of detecting, by a differential obstacle detector, a differential obstacle corresponding to a difference from an obstacle recorded on a predefined map on the basis of information from a sensor that acquires travel environment information of the robot, and
an approach area correcting step of correcting, by an approach area corrector, in consideration of the differential obstacle, a preset approach area in which a work by the robot is determined to be executable without contact with the obstacle, and generating a corrected approach area, the preset approach area including an area recorded in the predefined map, in which
the approach area correcting step includes determining whether or not a sampling point set inside the preset approach area allows the robot to work without contacting the differential obstacle, and generating the corrected approach area.

Furthermore, a fourth aspect of the present disclosure is
an information processing method executed in an information processing system including a user terminal and an information processing device attached to a robot, the method including
generating, by the user terminal, a predefined map including a location of an obstacle in a travel environment of the robot and a preset approach area in which a work by the robot is determined to be executable without contact with the obstacle, and inputting the predefined map to the information processing device attached to the robot, and
executing, by the information processing device attached to the robot,
differential obstacle detecting processing of detecting a differential obstacle corresponding to a difference from the obstacle recorded in the predefined map input from the user terminal on the basis of information from a sensor that acquires travel environment information of the robot, and
approach area correction processing of correcting, in consideration of the differential obstacle, a preset approach area in which the work by the robot is determined to be executable without contact with the obstacle, and generating a corrected approach area, the preset approach area including an area recorded in the predefined map, in which
the approach area correction processing includes determining whether or not a sampling point set inside the preset approach area allows the robot to work without contacting the differential obstacle, and generating the corrected approach area.

Furthermore, a fifth aspect of the present disclosure is a program that causes an information processing device to execute information processing, the information processing including
a differential obstacle detecting step of causing a differential obstacle detector to detect a differential obstacle corresponding to a difference from an obstacle recorded on a predefined map on the basis of information from a sensor that acquires travel environment information of the robot, and
an approach area correcting step of causing an approach area corrector to correct, in consideration of the differential obstacle, a preset approach area in which a work by the robot is determined to be executable without contact with the obstacle, and generate a corrected approach area, the preset approach area including an area recorded in the predefined map, in which
the approach area correcting step includes determining whether or not a sampling point set inside the preset approach area allows the robot to work without contacting the differential obstacle, and generating the corrected approach area.

Note that the program of the present disclosure is, for example, a program that can be provided by a storage medium or a communication medium that provides a variety of program codes in a computer-readable format, to an information processing device or a computer system capable of executing the program codes. By providing such a program in a computer-readable format, processing corresponding to the program is implemented on the information processing device or the computer system.

Other objects, features, and advantages of the present disclosure will become apparent from a more detailed description based on an embodiment of the present disclosure described later and the accompanying drawings. Note that a system herein described is a logical set configuration of a plurality of devices, and is not limited to a system in which devices with respective configurations are in the same housing.

The configuration according to an embodiment of the present disclosure can achieve a device and a method that can quickly correct an approach area defined as a work area of a robot when a new obstacle that is not on a predefined map occurs.

Specifically, for example, there are provided a differential obstacle detector that detects a differential obstacle corresponding to a difference from an obstacle recorded on a predefined map on the basis of information from a sensor that acquires travel environment information of the robot, and an approach area corrector that corrects, in consideration of the differential obstacle, a preset approach area in which a work by the robot is determined to be executable without contact with the obstacle, and generates a corrected approach area, the preset approach area including an area recorded on the predefined map. The approach area corrector determines whether or not a sampling point set inside the preset approach area allows the robot to work without contacting the differential obstacle, and generates the corrected approach area.

This configuration can achieve a device and a method that can quickly correct the approach area defined as the work area of the robot when a new obstacle that is not on the predefined map occurs.

Note that the effects herein described are only examples and are not restrictive, and additional effects may also be provided.

### BRIEF DESCRIPTION OF DRAWINGS

FIG. 1 is a diagram illustrating an overall configuration example of an information processing system that executes processing of the present disclosure.

FIG. 2 is a diagram illustrating an example of an information processing device incorporated in a robot.

FIG. 3 is a diagram illustrating a configuration example of the information processing device incorporated in the robot.

FIG. 4 is a diagram illustrating a predefined map and an example of movement of a robot using the predefined map and a work sequence.

FIG. 5 is a diagram illustrating an example of an “obstacle map” generated by an obstacle map creator and an example of an “integrated environment map” generated by an environment map integrator.

FIG. 6 is a diagram illustrating a configuration example of a user terminal.

FIG. 7 is a diagram illustrating an example of information for work definition data generation input to the user terminal by a user.

FIG. 8 is a diagram for describing a specific example of the “predefined map” generated by a work definition data manager together with an approach area generator and a predefined map generator.

FIG. 9 is a diagram for describing a specific example of “work sequence information” generated by the work definition data manager.

FIG. 10 is a diagram illustrating a specific example of a motion image of the robot according to the work sequence.

FIG. 11 is a diagram for describing a specific example of “work motion information” generated by the work definition data manager.

FIG. 12 is a diagram describing a specific example of approach area generation processing executed by the approach area generator.

FIG. 13 is a diagram illustrating a specific example of an approach area decided by determination processing of each sampling point.

FIG. 14 is a flowchart illustrating an example of a processing sequence of the approach area generation processing executed by the approach area generator of the user terminal.

FIG. 15 is a diagram describing a specific example of processing executed by the approach area generator of the user terminal.

FIG. 16 is a diagram illustrating a specific example of processing executed by the approach area generator of the user terminal.

FIG. 17 is a diagram illustrating a specific example of processing executed by the approach area generator of the user terminal.

FIG. 18 is a diagram illustrating a specific example of processing executed by the approach area generator of the user terminal.

FIG. 19 is a diagram describing a specific example of processing executed by the approach area generator of the user terminal.

FIG. 20 is a diagram illustrating a specific example of processing executed by the approach area generator of the user terminal.

FIG. 21 is a diagram illustrating a specific example of a motion image of the robot according to the work sequence.

FIG. 22 is a diagram for describing a specific example in which a preset approach area on the “predefined map” is an area where work cannot be executed in a case where a “differential obstacle (new obstacle)” is detected.

FIG. 23 is a diagram for describing a specific example of correction of the approach area executed by an approach area corrector.

FIG. 24 is a diagram for describing a specific example of the correction of the approach area executed by the approach area corrector.

FIG. 25 is a flowchart for describing a sequence of correction processing of the approach area executed by the approach area corrector.

FIG. 26 is a diagram for describing a specific example of the correction of the approach area executed by the approach area corrector.

FIG. 27 is a diagram for describing a specific example of the correction of the approach area executed by the approach area corrector.

FIG. 28 is a diagram for describing a specific example of a motion example of the robot in a case where work according to the work sequence is executed.

FIG. 29 is a diagram for explaining a hardware configuration example of the information processing device of the present disclosure.

### MODE FOR CARRYING OUT THE INVENTION

Hereinafter, an information processing device, an information processing system, an information processing method, and a program of the present disclosure will be described in detail with reference to the drawings. Note that the description will be made in accordance with the following items.
1. Overall configuration example of information processing system that executes processing of present disclosure
2. Configurations of information processing device and user terminal
3. Details of work definition data generation processing in user terminal
4. Processing sequence of approach area generation processing
5. Details of motion of robot based on work definition data
6. Processing sequence of approach area correction processing executed by approach area corrector of information processing device of robot
7. Work sequence by robot using environment map reflecting corrected approach area generated by information processing device of robot
8. Hardware configuration example of information processing device of present disclosure
9. Summary of configuration of present disclosure

### 1. Overall Configuration Example of Information Processing System that Executes Processing of Present Disclosure

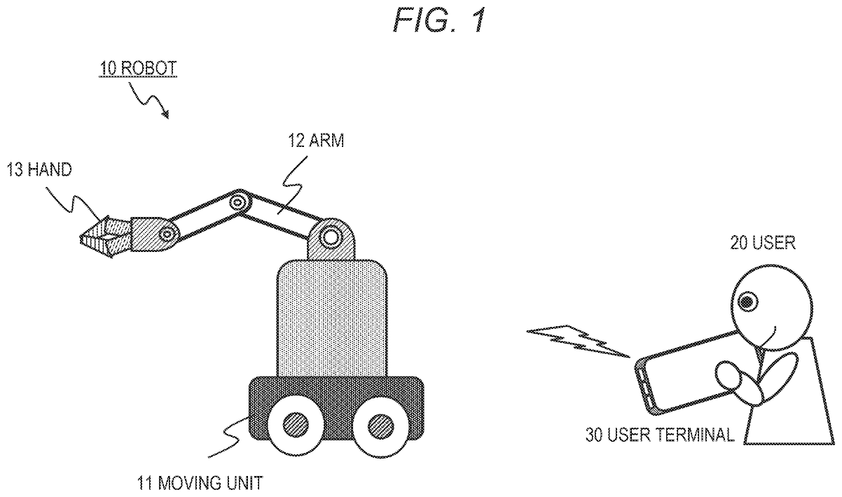

First, an overall configuration example of an information processing system that executes processing of the present disclosure will be described with reference to FIG. 1.

As illustrated in FIG. 1, the information processing system that executes the processing of the present disclosure is a system including a robot 10 and a user terminal 30 operated by a user 20.

The robot 10 has, for example, wheels or the like, and includes a moving unit 11 that travels and moves on a floor surface, an arm 12 and a hand 13 that operate an object or the like to be a work target. That is, the robot is a mobile manipulator type robot in which a manipulator including the arm 12 and the hand 13 for work is mounted on the moving unit 11.

The mobile manipulator type robot 10 can perform work in various work areas by moving.

Note that an information processing device for controlling the robot 10, communicating with the outside, and the like is incorporated inside the robot 10.

A detailed configuration of the information processing device will be described later.

The user terminal 30 is used by the user of the robot 10 to input information for work to be performed by the robot 10 and an environment (such as a structure of a room) in which the robot 10 is used.

In addition, an instruction such as start or stop of work to the robot can be operated and a state of the robot can also be displayed via the user terminal 10.

Specifically, the user terminal 30 can be configured by various information processing devices such as a tablet terminal, a smartphone, and a PC, for example.

The robot 10 and the user terminal 30 can communicate with each other.

Note that all of the processing executed by using the user terminal 30 and the functions of the user terminal 30 can be incorporated in the information processing device inside the robot 10. In this case, the processing of the present disclosure can be executed by the robot 10 alone without using the user terminal 30.

As described above, the information processing device for controlling the robot 10, communicating with the outside, and the like is incorporated inside the robot 10.

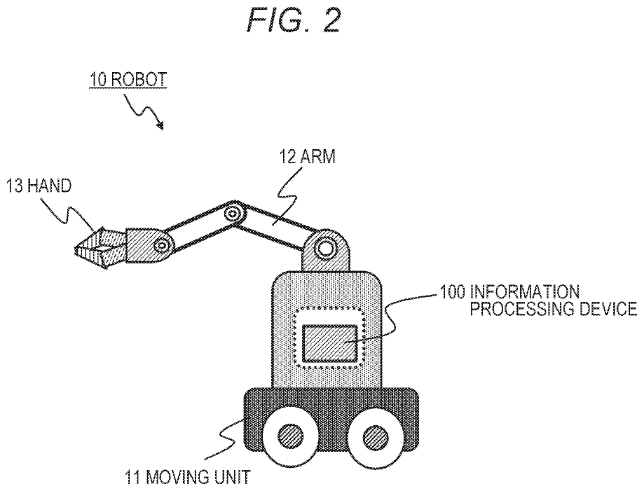

For example, as illustrated in FIG. 2, an information processing device 100 is incorporated inside the robot 10.

### 2. Configurations of Information Processing Device and User Terminal

Next, configurations of the information processing device inside the robot 10 and the user terminal will be described.

As described with reference to FIG. 2, the information processing device 100 is incorporated inside the robot 10.

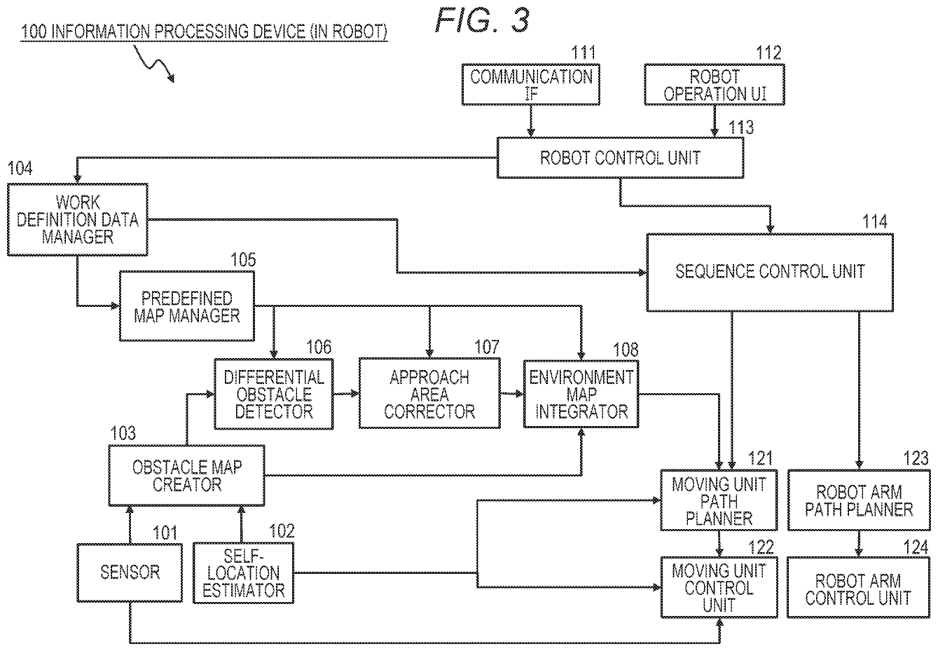

A configuration example of the information processing device 100 will be described with reference to FIG. 3.

As illustrated in FIG. 3, the information processing device 100 includes a sensor 101, a self-location estimator 102, an obstacle map creator 103, a work definition data manager 104, a predefined map manager 105, a differential obstacle detector 106, an approach area corrector 107, an environment map integrator 108, a communication IIF 111, a robot operation UI 112, a robot control unit 113, a sequence control unit 114, a moving unit path planner 121, a moving unit control unit 122, a robot arm path planner 123, and a robot arm control unit 124.

The sensor 101 is a sensor for detecting a surrounding environment such as an obstacle around the robot, and includes, for example, a camera, light detection and ranging (LiDAR), and the like.

Note that the sensor 101 is not limited to the camera and the LiDAR, and may include other sensors. For example, the sensor 101 may be provided with a ToF sensor, an ultrasonic sensor, a radar, a sonar, or the like.

The self-location estimator 102 estimates a current location of the robot 10 by using information and the like acquired from the sensor 101.

Note that the self-location estimation processing by the self-location estimator 102 may be executed as processing using information such as an inertial measurement unit (IMU) and rotation angles of the wheels, information from an external camera, and the like in addition to the information acquired from the sensor 101.

The self-location calculator 102 estimates a self-location with application of simultaneous localization and mapping (SLAM) processing, for example.

The SLAM processing is processing of estimating a three-dimensional location of a characteristic point by capturing an image (moving image) with a camera and analyzing a trajectory of the characteristic point included in a plurality of captured images, and of estimating (localizing) a location and orientation of the camera (self), and the SLAM processing is capable of creating (mapping) a surrounding map (environment map) by using three-dimensional location information of the characteristic point.

The obstacle map creator 103 creates an “obstacle map” which is a map indicating arrangement locations of obstacles existing around the robot 10 by using, for example, surrounding information obtained by the sensor 101 and current location information of the robot 10 calculated by the self-location estimator 102.

The obstacle map creator 103 creates an “obstacle map” such as an occupancy grid map, for example.

The occupancy grid map (grid map) is a map in which a probability value of presence of an obstacle in each section (grid) defined by a lattice is set.

The robot 10 can travel safely without colliding with an obstacle by selecting, as a traveling route, a section (grid) in which the probability of the presence of an obstacle is low, among sections of the occupancy grid map (grid map) and traveling in the section.

The predefined map manager 105 acquires a “predefined map” from the work definition data manager 104, and provides the acquired “predefined map” to the differential obstacle detector 106, the approach area corrector 107, and the environment map integrator 108.

Note that work definition data managed by the work definition data manager 104 includes the following data:
(1) predefined map;
(2) work sequence information; and
(3) work motion information.

These data will be described in detail later.

The “predefined map” is a map defining an obstacle location in a travel environment where the robot 10 travels and an “approach area” which is a work allowable area where the robot 10 is determined to be able to safely execute work by driving the arm 12 and the hand 13 in the work area.

Note that the “predefined map” is a map created before the start of traveling of the robot 10, that is, created in advance.

The “predefined map” is created by the user 20 using the user terminal 30, for example, and is transmitted from the user terminal 30 to the information processing device 100 of the robot 10. The transmission data from the user terminal 30 is input to the work definition data manager 104 via the communication IF 111 and the robot control unit 113, and is stored in a storage in the work definition data manager 104 or a storage accessible by the work definition data manager 104.

Note that the “predefined map” may be directly input by the user 20 via the robot operation UI 112.

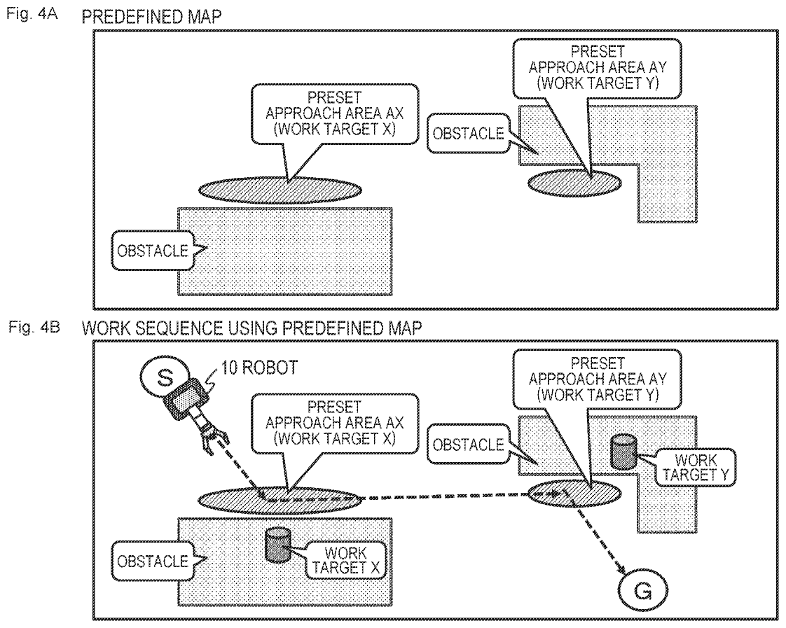

FIG. 4(1a) illustrates an example of the “predefined map”.

In FIG. 4(1a), two obstacles and a “preset approach area” set near each obstacle are recorded in the “predefined map”. Note that the “approach area” recorded in the “predefined map” is referred to as “preset approach area”.

FIG. 4(1b) is a diagram illustrating an example of movement and a work sequence of the robot 10 using the “predefined map” illustrated in FIG. 4(1a).

The robot 10 starts to move from a start point (S) and reaches a “preset approach area AX”, and then, the robot performs work on a work target X in the “preset approach area AX”. For example, work such as gripping processing and moving processing of the work target X is executed.

This work is completed, and then, the robot 10 moves to the next work area. That is, the user moves to the “preset approach area AY” recorded in the “predefined map”. The robot 10 reaches a “preset approach area AY”, and then, the robot performs work on a work target Y in the “preset approach area AY”. For example, work such as the gripping processing and the moving processing of the work target Y is executed. Thereafter, the robot moves to a goal point (G) and ends the processing.

In this manner, the “approach area” is an area where the robot 10 drives the arm 12 and the hand 13 to execute work, and the “approach area” recorded in the “predefined map” is referred to as “preset approach area”.

As illustrated in FIG. 4(1b), the robot 10 moves to the “preset approach area AX” by the moving processing using the moving unit 11, and performs work such as, for example, gripping of one work target X by driving the arm 12 and the hand 13 in the “preset approach area AX”.

Thereafter, the robot 10 moves to the “preset approach area AY”, and performs another work, for example, a work such as, for example, gripping of the work target Y in the “preset approach area AY”.

In this manner, the “approach area” is an area defined as an area where the robot 10 can execute a scheduled work without colliding or contacting with the obstacle, and the “preset approach area”, which is an area where the robot 10 can execute the scheduled work without colliding or contacting with the obstacle, is recorded in the “predefined map” created in advance.

As described above, the predefined map manager 105 acquires the “predefined map” from the work definition data manager 104, and provides the acquired “predefined map” to the differential obstacle detector 106, the approach area corrector 107, and the environment map integrator 108.

The “predefined map” records the obstacle location in the travel environment where the robot 10 travels and the “preset approach area” which is the work allowable area where the robot 10 is determined to be able to safely execute work by driving the arm 12 and the hand 13 in the work area.

However, the “predefined map” is a map created before the robot 10 travels, and in a case where the new obstacle is placed after the creation of the “predefined map”, the robot 10 may not be able to perform work even in the “preset approach area”.

On the other hand, the “obstacle map” created by the obstacle map creator 103 described above is a map using the surrounding information obtained by the sensor 101 of the robot 10 and the current location information of the robot 10 calculated by the self-location estimator 102, and is a map including the latest obstacle information around the robot 10.

The differential obstacle detector 106 compares the “predefined map” created in advance with the “obstacle map” including the latest obstacle information around the robot 10, and detects a new obstacle not existing on the “predefined map” as a “differential obstacle”.

The approach area corrector 107 inputs each of the following information:
(a) the “predefined map” from the predefined map manager 105; and
(b) “differential obstacle” information which is a new obstacle not existing on the “predefined map” detected by the differential obstacle detector 106.

The approach area corrector 107 uses the above input information to perform correction processing of the “preset approach area” defined on the “predefined map”.

Specifically, a “corrected approach area” is generated in consideration of the “differential obstacle” which is a new obstacle not existing on the “predefined map” detected by the differential obstacle detector 106.

The environment map integrator 108 inputs each of the following information:
(a) the “predefined map” from the predefined map manager 105;
(b) the “obstacle map” from the obstacle map creator 103; and
(c) “corrected approach area information” and “differential obstacle information” from the approach area corrector 107.

The environment map integrator 108 creates an “integrated environment map” by using the above input information.

That is, the “integrated environment map” is created in which the latest location of the obstacle and the “corrected approach area” obtained by correcting the “preset approach area” recorded in the “predefined map” on the basis of the latest location of the obstacle are recorded.

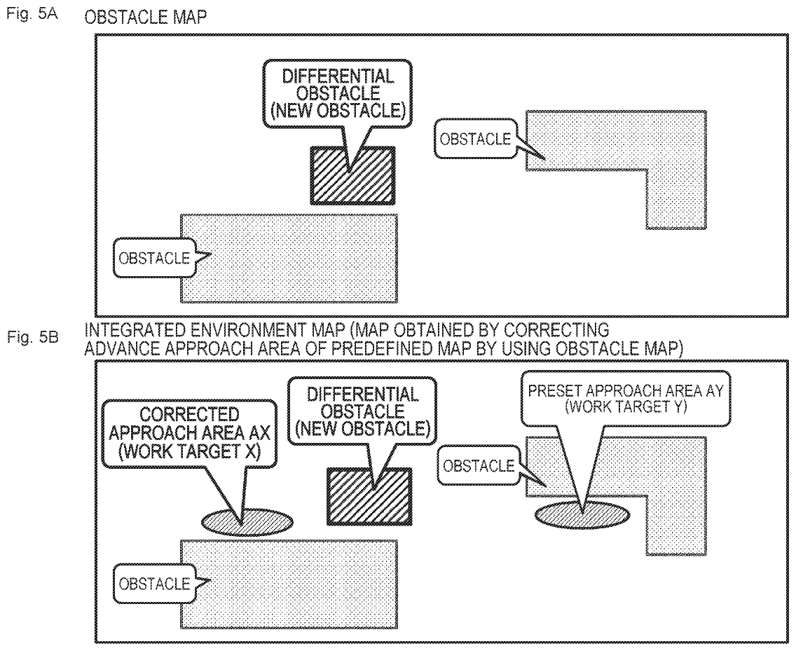

Examples of the “obstacle map” generated by the obstacle map creator 103 and the “integrated environment map” generated by the environment map integrator 108 will be described with reference to FIG. 5.

FIG. 5(2a) is a diagram illustrating an example of the “obstacle map” generated by the obstacle map creator 103.

The “obstacle map” illustrated in FIG. 5(2a) is a map of the same place as the place in the “predefined map” described above with reference to FIG. 4(1a).

The “predefined map” described with reference to FIG. 4(1a) is a map created before the robot 10 travels, whereas the “obstacle map” illustrated in FIG. 5(2a) is a map reflecting the latest obstacle location created on the basis of the information acquired by the sensor of the robot 10.

The “obstacle map” illustrated in FIG. 5(2a) includes a new “differential obstacle” which is not included in the “predefined map” described above with reference to FIG. 4(1a).

The “differential obstacle” is an obstacle not existing at the time of creating the “predefined map”, and is an obstacle newly detected at the time of creating the “obstacle map”.

In the “predefined map” described with reference to FIG. 4(1a), the “preset approach area” which is an area that allows the robot 10 to work is recorded, but the “preset approach area” recorded in the “predefined map” is an area where the presence of a new “differential obstacle” is not considered.

The environment map integrator 108 corrects the “preset approach area” recorded in the “predefined map” in consideration of the “differential obstacle (new obstacle)”, and creates an “integrated environment map” in which the “corrected approach area” is recorded.

That is, an “integrated environment map” as illustrated in FIG. 5(2b) is created.

The environment map integrator 108 uses the following input information:
(a) the “predefined map” from the predefined map manager 105;
(b) the “obstacle map” from the obstacle map creator 103; and
(c) “corrected approach area information” and “differential obstacle information” from the approach area corrector 107
to create the “integrated environment map” in which the “corrected approach area” obtained by correcting the “preset approach area” recorded in the “predefined map” on the basis of the latest location of the obstacle, that is, the “integrated environment map” as illustrated in FIG. 5(2b).

The “corrected approach area” recorded in the “integrated environment map” illustrated in FIG. 5(2b) is defined as a work area where the robot 10 can execute scheduled work without contacting an existing obstacle or the differential obstacle (new obstacle).

Note that specific generation processing of an approach area and correction processing will be described later.

The description of the configuration of the information processing device 100 will be continued with reference to FIG. 3 again.

The sequence control unit 114 moves the moving unit 11, the arm 12, and the hand 13 of the robot 10 on the basis of the work sequence defined in the work definition data, manages the progress, and performs sequence control.

The moving unit path planner 121 moves the moving unit 11 of the robot 10 to an instructed location in accordance with an instruction from the sequence control unit 114.

On the basis of the “integrated environment map” generated by the environment map integrator 108 and the self-location estimated by the self-location estimator 102, the moving unit path planner 121 generates path information (travel route information) that allows traveling of a via-point on a movement path of the robot 10 instructed by the sequence control unit 114 and an approach area that is a work allowable area at each work location while avoiding obstacles, and outputs the generated path information to a moving body control unit 122.

Note that, in a case where the sensor 101 detects a new obstacle while the robot 10 is traveling, the environment map integrator 108 sequentially updates the “integrated environment map”. That is, the “integrated environment map” in which the new obstacle and the “corrected approach area” corrected in accordance with the location of the new obstacle are recorded is updated.

In a case where the “integrated environment map” is updated by the environment map integrator 108, the moving unit path planner 121 updates the path information (travel route information) by using the updated latest “integrated environment map”, and outputs the updated path information to the moving body control unit 122.

The moving body control unit 122 controls the moving unit 11 of the robot to move the robot 10 in accordance with the path information (travel route information) on the basis of the path information (travel route information) generated by the moving body path planner 121 and the self-location of the robot 10 estimated by the self-location estimator 102. For example, control of a motor driver or the like that drives the wheels of the moving unit 11 is executed.

In accordance with an instruction from the sequence control unit 114, the robot arm path planner 123 plans a path (trajectory) of the arm 12 and the hand 13 of the robot 10 for performing the instructed work, and outputs the generated path (trajectory) to the robot arm control unit 124.

The robot arm control unit 124 drives a drive unit of joints and the like of the arm and the hand 13 of the robot 10 so that the arm 12 and the hand 13 of the robot 10 move by using the path (trajectory) of the arm 12 and the hand 13 of the robot 10 generated by the robot arm path planner 123. For example, a motor driver of joints and the like of the arm and the hand 13 of the robot 10 is controlled.

The communication IF 111 communicates with an external device, for example, the user terminal 30, and receives the work definition data created by the user terminal 30 and robot operation information input from the user terminal 30 by the user 20. Furthermore, a state of the robot 10, a progress status of work of the robot 10, and the like may be transmitted to the user terminal 30.

The robot operation UI 112 is a user interface including a touch panel or the like mounted on the body of the robot 10. The state of the robot 10, a list of work definition data received from the outside by the robot 10, and the like are displayed, and instructions such as selection of work and start and stop of the work are input. Furthermore, the progress status of the work of the robot 10 may be displayed.

The robot control unit 113 inputs instruction data input from an external device such as the user terminal 30 via the robot operation UI 112 or the communication I/F 111, and executes processing of transferring necessary information to the work definition data manager 104 and the sequence control unit 114 and control processing of the entire robot 10.

Note that, in the above description, it has been described that the differential obstacle detector 106 detects a new obstacle not existing in the “predefined map”, and the environment map integrator 108 generates the “integrated environment map” in which the “corrected approach area” is recorded in consideration of the new obstacle.

The differential obstacle detector 106 may detect not only a new obstacle not existing in the “predefined map” but also, for example, movement of an existing obstacle recorded in the “predefined map”.

The approach area corrector 107 decides the “corrected approach area” in consideration of not only the new obstacle but also a movement location of the existing obstacle. In this case, the environment map integrator 108 generates the “integrated environment map” in which the “corrected approach area” corrected in consideration of not only the new obstacle but also the movement location of the existing obstacle is recorded.

Furthermore, the differential obstacle detector 106 may be configured to detect a change in the location of a work target object.

The approach area corrector 107 decides a “corrected approach area” in consideration of a change in the location of the work target object. In this case, the environment map integrator 108 generates the “integrated environment map” in which the “corrected approach area” corrected in consideration of the change in the location of the work target object is recorded.

In this manner, the differential obstacle detector 106 can detect not only obstacles but also various environmental changes different from the “predefined map”, and the approach area corrector 107 can decide the “corrected approach area” in consideration of the various environmental changes detected by the differential obstacle detector.

In this case, the environment map integrator 108 generates the “integrated environment map” in which the “corrected approach area” corrected in consideration of the various environmental changes is recorded.

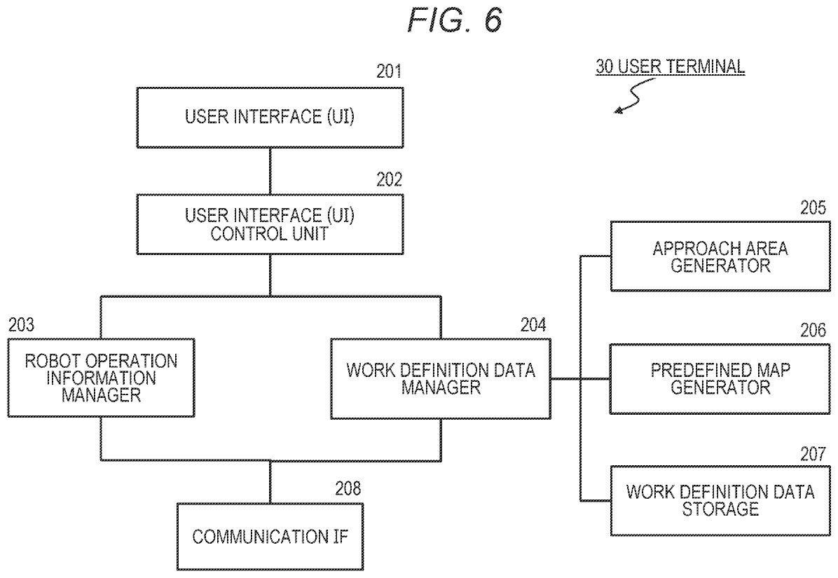

Next, a configuration example of the user terminal 30 will be described with reference to FIG. 6.

As described above, the user terminal 30 includes, for example, various information processing devices such as a tablet terminal, a smartphone, and a PC.

The user terminal 30 has a function as a UI for operating the robot 10 and a function as a UI for creating work definition data that defines work to be performed by the robot 10.

As illustrated in FIG. 6, the user terminal 30 includes a user interface (UI) 201, a user interface (UI) control unit 202, a robot operation information manager 203, a work definition data manager 204, an approach area generator 205, a predefined map generator 206, a work definition data storage 207, and a communication IF 208.

The user interface (UI) 201 includes, for example, a touch panel type display unit capable of performing input processing and data display processing of user operation information on the user terminal 30.

Various data are displayed under the control of the user interface (UI) control unit 202.

Furthermore, the user 20 can input various information available for controlling the robot 10, for example, work sequence information, travel path information, and the like.

The information input by the user to the user interface (UI) 201 is output to the user interface (UI) control unit 202 via the user interface (UI) 201.

The user interface (UI) control unit 202 switches contents to be displayed on the user interface (UI) 201 in accordance with the information input by the user 20.

Furthermore, the user interface (UI) control unit 202 outputs the input information to the user interface (UI) 201 by the user 20 to the robot operation information manager 203 and the work definition data manager 204.

The robot operation information manager203 acquires, for example, the state of the robot 10 input from the information processing device 100 of the robot 10 via the communication IF 208, a list of the work definition data received by the robot 10, the progress status of the ongoing work, and the like, generates display contents on the user interface (UI) 201, and outputs the display contents to the user interface (UI) control unit 202.

In addition, when receiving the input information from the user via the user interface (UI) control unit 202, the robot operation information manager 203 transmits the user input information to the robot 10 via the communication IF 208. The user input information is, for example, selection information of work to be executed by the robot 10 or instruction data such as start and stop of the work.

The work definition data manager 204 generates a work definition data creation UI and outputs the work definition data creation UI to the user interface (UI) 201 via the user interface (UI) control unit 202, acquires work definition data input by the user 20 by using the work definition data creation UI, stores the work definition data in the work definition data storage 207, and transmits the work definition data to the information processing device 100 of the robot 10 via the communication IF 208.

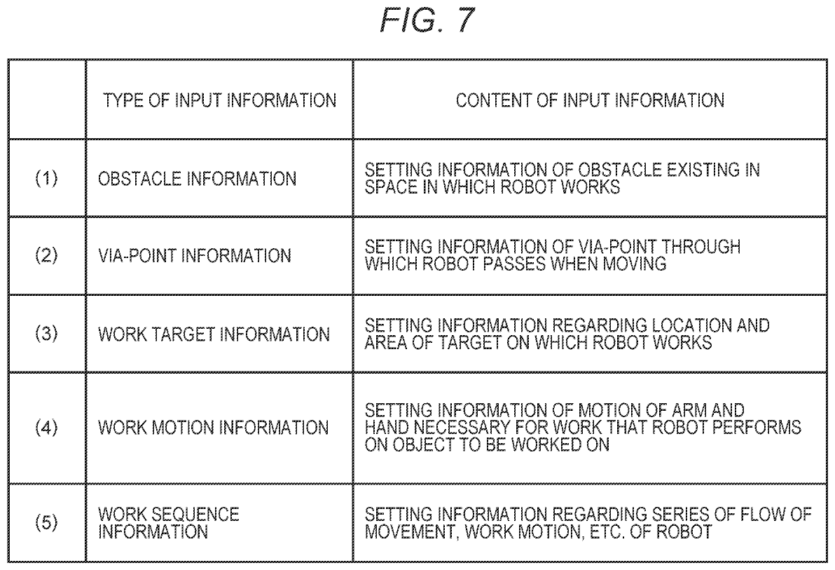

Note that work definition data generation information input by the user 20 via the user interface (UI) 201 is, for example, information as illustrated in FIG. 7. That is, the information is as follows.
(1) Obstacle information=setting information of an obstacle existing in a space where the robot works
(2) Via-point information=setting information of a via-point through which the robot passes when moving
(3) Work target information=setting information of a location or an area of a target on which the robot performs work
(4) Work motion information=setting information of the motion of the arm and the hand necessary for the work performed by the robot on an object to be worked on
(5) Work sequence information=setting information regarding a series of flow such as movement and work motion of the robot

For example, the work definition data manager 204 outputs a UI available for inputting, for example, the work definition data generation information of (1) to (5) described above to the user interface (UI) 201 via the user interface (UI) control unit 202.

Furthermore, the work definition data manager 204 generates work definition data together with the approach area generator 205 and the predefined map generator 206 in accordance with information input by the user via the user interface (UI) 201, stores the generated work definition data in the work definition data storage, and transmits the work definition data to the information processing device 100 of the robot 10 via the communication IF 208.

Note that the work definition data generated by the work definition data manager 204 together with the approach area generator 205 and the predefined map generator 206 is data including the following data:
(1) predefined map;
(2) work sequence information; and
(3) work motion information.

These data will be described in detail later.

The approach area generator 205 inputs user input information necessary for generating the approach area via the work definition data manager 204, and decides a “preset approach area” corresponding to each work area. By using the location and area of the work target input by the user, a work motion, and the obstacle information, an area in which the robot 10 can perform a scheduled work on the work target object without interfering with (contacting) the obstacle is generated as a “preset approach area”.

The predefined map generator 206 generates a “predefined map”.

The predefined map generator 206 generates the “predefined map” by inputting information necessary for generating the “predefined map” via the work definition data manager 204. For example, the “predefined map” is generated by inputting obstacle location information and via-point information included in user setting information input via the user interface (UI) 201, “preset approach area” information generated by the approach area generator 205, and the like.

The work definition data manager 204 stores the user setting information input via the user interface (UI) 201, that is, the user setting information described with reference to FIG. 7, and the work definition data including the “predefined map” generated by the predefined map generator 206 in the work definition data storage 207, and transmits the work definition data to the information processing device 100 of the robot 10 via the communication IF 208.

Note that, in the present embodiment, generation of the approach area and generation processing of the “predefined map” are executed in the user terminal 30, but these processing may be requested to an external server via the communication IF 208.

The work definition data storage 207 stores the work definition data generated by the work definition data manager 204 in accordance with an instruction from the work definition data manager 204. Note that the work definition data includes the user setting information described with reference to FIG. 7 and the “predefined map” generated by the predefined map generator 206.

Specifically, the work definition data storage 207 includes, for example, a non-volatile storage such as a flash memory.

The communication IF 208 communicates with the information processing device 100 of the robot 10, and transmits the work definition data created by the user 20 in the user terminal 30 and input information and operation information performed by using the UI 201 on the user terminal 30. Furthermore, information such as robot state information and a work progress status is received from the information processing device 100 of the robot 10. The received information is output and displayed on a user interface (UI) 201 via the robot operation information manager 203.

Note that, as described above, all the functions of the user terminal 30 can be incorporated in the information processing device inside the robot 10. In this case, the configuration illustrated in FIG. 6 is configured in the information processing device 100 of the robot 10.

With such a configuration, the processing of the present disclosure is executed by the robot 10 alone without using the user terminal 30.

As described above, the work definition data generated by the work definition data manager 204 together with the approach area generator 205 and the predefined map generator 206 is data including the following data:
(1) predefined map;
(2) work sequence information; and
(3) work motion information.

These data will be described in detail below.

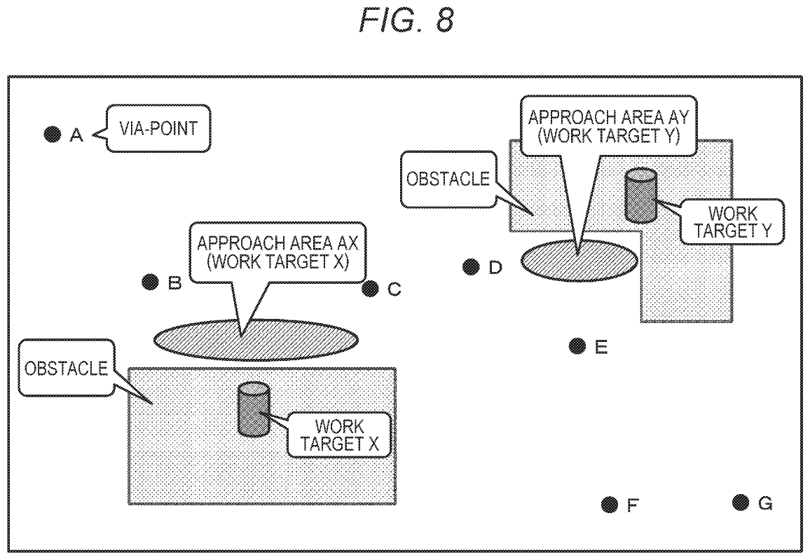

First, a specific example of the “predefined map” generated by the work definition data manager 204 together with the approach area generator 205 and the predefined map generator 206 will be described with reference to FIG. 8.

Note that the example illustrated in FIG. 8 is a two-dimensional (2D) map, but may be a three-dimensional (3D) map. In addition, a map in a lattice pattern, such as a grid map or Voxel Map, may be used. Alternatively, the map may be a vector map having only vertex information of a shape surrounding each area.

As described above, the “predefined map” is a map in which information of an obstacle in a work space of the robot 10 and the “preset approach area” which is a work area where the work instructed by the user is executable without contacting the obstacle are recorded.

Furthermore, via-point information, work target information, and the like of the robot designated by the user are also recorded.

As illustrated in FIG. 8, via-points A to G are recorded in the “predefined map”. These via-points A to G are information input by the user and are information designating that the robot 10 is moved in the order of A to G. The via-point A is a start location, and the via-point G is a goal location.

The via-point is set to designate a route for the robot to pass through when the robot moves in the space. The via-points are set in a movable area (not an obstacle area) on the map.

Note that the via-points A to G are illustrated as points on the map illustrated in FIG. 8, but location information of each point is recorded in attribute data attached to the map.

In the “predefined map”, the work target information is further recorded. In the example illustrated in FIG. 8, the two work targets, that is, the work target X and the work target Y, are recorded.

Note that, in the map illustrated in FIG. 8, cylindrical figures are illustrated as the work targets X and Y. However, location information, area information, three-dimensional shape information, and the like of each work target are recorded in the attribute data attached to the map.

The location information and the area information of the work target are information indicating a location and an area where an object on which the robot 10 performs work by using the arm 12 and the hand 13 is placed.

Furthermore, in a case where a plurality of objects to be worked on is placed or when no work object is positioned, a range in which the objects to be worked are placed is recorded as area information.

The obstacle is an obstacle that the robot 10 can possibly contact or collide with. Note that, although the map illustrated in FIG. 8 illustrates a planar figure as an obstacle, the location, area information, three-dimensional shape information, and the like of each obstacle are recorded in the attribute data attached to the map.

For example, in addition to a physical obstacle such as a desk or a shelf, an area where entry of the robot is desired to be prohibited can also be set as the obstacle. Note that the obstacle may be expressed in 2D or in 3D together with height information.

Note that the obstacle area is an area that only the moving unit 11 of the robot 10 cannot enter, and the arm 12 of the robot 10 can enter. However, if necessary, the arm 12 of the robot 10 can be set as an obstacle area even in an area that the arm can enter.

The “approach area” is an area defined as a work area where the work instructed by the user is executable without contacting the obstacle, and is individually set for each of the work targets X and Y. Note that, as described above, the “approach area” defined in the “predefined map” is a “preset approach area”.

As described above with reference to FIG. 5 and the like, in some cases, the “preset approach area” is corrected by using the “obstacle map” generated by using sensor detection information of the robot 10.

Note that the approach area illustrated in FIG. 8 has an elliptical shape, but may have a more complicated shape reflecting kinematics of a robot arm.

In addition, in a case where sampling points are generated when the approach area is generated, information regarding the sampling points may be held together.

Note that a method of generating an approach area by using sampling points will be described later.

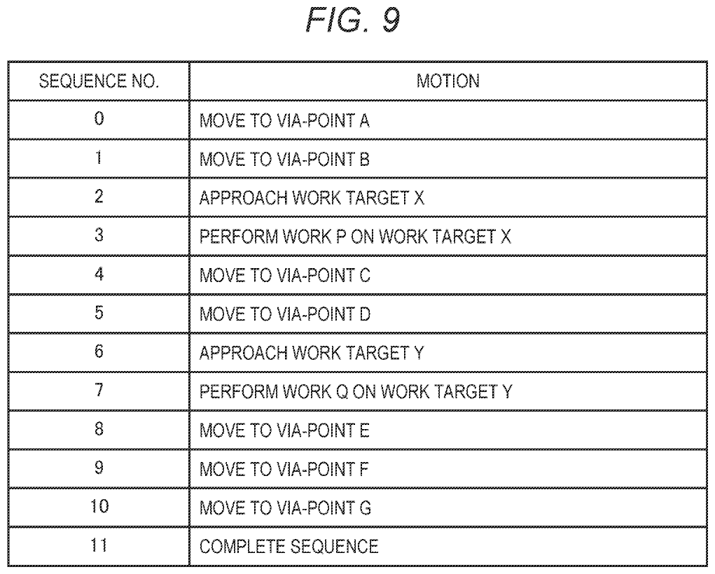

Next, a specific example of the “work sequence information” generated by the work definition data manager 204 will be described with reference to FIG. 9.

The work definition data manager 204 generates “work sequence information” as work definition data in accordance with user input information, that is, “(5) work sequence information” in the user input information described above with reference to FIG. 7.

As illustrated in FIG. 9, the “work sequence information” generated by the work definition data manager 204 is information in which moving processing and work to be executed by the robot 10 are arranged in time series.

The moving processing and work information to be executed by the robot 10 are recorded in association with sequence numbers in time series.

The “work sequence information” illustrated in FIG. 9 records a sequence in which the robot standing by at the point A performs work on the work target X, then moves to perform work on the work target Y, and then moves to the point G.

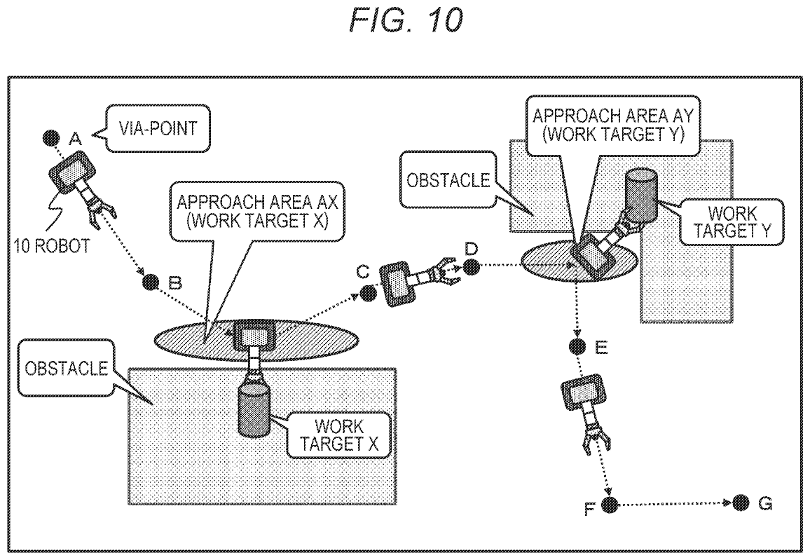

A motion image of the robot according to this work sequence is illustrated in FIG. 10.

As illustrated in FIG. 10, the robot 10 moves from the via-point A to the via-point B and enters the approach area AX corresponding to the work target X. Thereafter, the robot 10 executes a scheduled work (P) on the work target X in the approach area AX. After completion of the scheduled work (P), the robot 10 enters the approach area AY corresponding to the work target Y through the via-points C and D. Thereafter, the robot 10 executes a scheduled work (Q) on the work target Y in the approach area AY. After completion of the scheduled work (Q), the robot 10 sequentially moved to the via-points E, F, and G and ends the sequence.

A motion sequence of the robot 10 according to the work sequence illustrated in FIG. 9 is as described above.

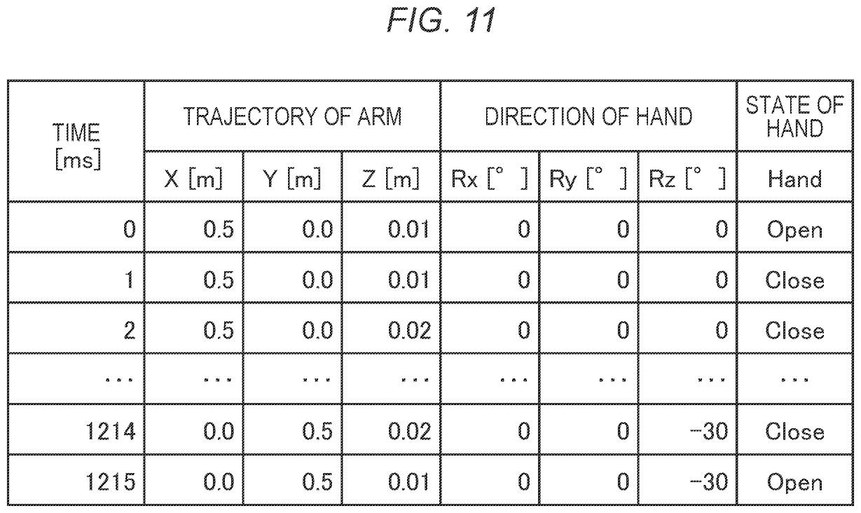

Next, a specific example of “work motion information” generated by the work definition data manager 204 will be described with reference to FIG. 11.

The work definition data manager 204 generates “work motion information” as work definition data in accordance with user input information, that is, “(4) work motion information” in the user input information described above with reference to FIG. 7.

The work motion information is setting information of the motion of the arm and the hand necessary for the work performed by the robot on the object to be worked on.

A specific example of the “work motion information” generated by the work definition data manager 204 is illustrated in FIG. 11.

As illustrated in FIG. 11, the “work motion information” generated by the work definition data manager 204 is data describing a trajectory of the arm 12 of the robot 10 and an orientation and a state (open/close) of the hand 13 in a case where the robot 10 reaches the approach area and performs scheduled work when performing work on the object to be worked on.

For example, the work P on the work target X described above with reference to FIG. 10, the trajectory of the arm 12 of the robot 10 for performing the work Q on the work target Y, and the direction and state (open/close) of the hand 13 are described.

As described above, the work definition data manager 204 of the user terminal 30, together with the approach area generator 205 and the predefined map generator 206, generates the “work definition data” including the following data:
(1) predefined map;
(2) work sequence information; and
(3) work motion information,
stores these data in the work definition data storage 207, and transmits the data to the information processing device 100 of the robot 10.

The information processing device 100 of the robot 10 causes the robot 10 to execute a predetermined motion, that is, the moving processing and the work processing in accordance with the “work definition data” including the above data of (1) to (3) received from the user terminal 30.

### 3. Details of Work Definition Data Generation Processing in User Terminal

Next, details of the work definition data generation processing in the user terminal 30 will be described.

As described above, generation processing of the “work definition data”, that is, the “work definition data” including the following data:
(1) predefined map;
(2) work sequence information; and
(3) work motion information
is executed in the user terminal 30 by using the user input information.

Details of the work definition data generation processing will be described below.

In the generation processing of the “work definition data”, the user terminal 30 performs generation processing of each of the following information:
(1) generation processing of obstacle information;
(2) generation processing of work target information;
(3) generation processing of via-point information
(4) generation processing of work motion information;
(5) generation processing of approach area information; and
(6) generation processing of work sequence information.

Hereinafter, specific examples of the generation processing of each of the information will be sequentially described.

### (1) Generation Processing of Obstacle Information;

First, a specific example of the generation processing of the obstacle information in the user terminal 30 will be described.

The user 20 sets a screen of the user terminal 30 to an obstacle setting mode, designates coordinates indicating the location of the obstacle on the screen, and draws a shape such as a rectangle, a rectangular parallelepiped, or a circle corresponding to the shape of the obstacle.

Alternatively, the robot 10 may be moved in advance in the work space, the “obstacle map” generated by the obstacle map creator 103 of the robot 10 at that time may be transferred to the user terminal 30, and an obstacle recorded in the “obstacle map” may be extracted in the user terminal 30 and used as the obstacle information.

### (2) Generation Processing of Work Target Information;

Next, a specific example of the generation processing of the work target information in the user terminal 30 will be described.

The user 20 sets the screen of the user terminal 30 to a work target object setting mode, and designates coordinates indicating the location of the work target object on the screen.

Note that the coordinates indicating the location of the work target object specify the location of the work target object to be gripped by the hand 13 of the robot 10. In addition, a shape such as a rectangle, a rectangular parallelepiped, or a circle corresponding to the shape of the work target object may be drawn.

### (3) Generation Processing of Via-Point Information

Next, a specific example of the generation processing of the via-point information in the user terminal 30 will be described.

The user 20 sets the screen of the user terminal 30 to a via-point input mode, and designates coordinates indicating the location of the via-point on the screen.

In addition, the via-point may be named.

### (4) Generation Processing of Work Motion Information;

Next, a specific example of the generation processing of the work motion information in the user terminal 30 will be described.

The work motion information is the data described above with reference to FIG. 11. That is, the work motion information is data describing the trajectory of the arm 12 of the robot 10 and the orientation and the state (open/close) of the hand 13 in a case where the robot 10 reaches the approach area and performs scheduled work when performing work on the object to be worked on.

When the work motion information is generated in the user terminal 30, the user 20 first sets the screen of the user terminal 30 to a work motion information input mode, and inputs the work motion of the arm 12 and the hand 13 of the robot 10 on the screen as time-series data.

For example, work desired to be performed on the work target object is input as time-series data of the location (tool center point (TCP)) of the hand 13 of the robot 10. The location of the hand (TCP) is a center position between the fingers if the hand is a two-finger gripper.

In addition, which work target the work is to be performed on is also set.

The work motion can be set by designating a via-point indicating a time-series trajectory of the hand 13 or the arm 12 in a 3D space.

Alternatively, the arm 12 or the hand 13 of the robot 10 may be moved on CG to take an arbitrary posture, and the posture may be registered in the order of movement.

Alternatively, direct teaching using the actual machine of the robot 10 may be performed, posture information of the robot 10 (actual machine) may be transferred to the user terminal 30, and the work motion information may be generated from the via-point indicating the time-series trajectory of the hand 13 and the arm 12 obtained from the transfer data.

### (5) Generation Processing of Approach Area Information; and

First, a specific example of the generation processing of the approach area information in the user terminal 30 will be described.

The approach area is an area where the robot 10 can perform scheduled work on the work target object without interfering with (contacting) an obstacle.

The user terminal 30 uses the location and area of the work target input by the user 20, the work motion, and the obstacle information to decide, the an “approach area”, an area where the robot 10 can perform scheduled work on the work target object without interfering with (contacting) the obstacle.

As described above with reference to FIG. 6, the generation processing of the approach area is executed in the approach area generator 205 of the user terminal 30.

The user 20 inputs the obstacle information, the work target information, and the work motion information via the user interface (UI) 201, and after completion of the input of each of these information, operates an approach area generation instruction icon displayed on the user interface (UI) 201. Then, the approach area generator 205 starts approach area generation processing.

Note that a timing of executing the approach area generation processing in the approach area generator 205 can be variously set. For example, the processing may be performed at a timing immediately before the work definition data generated by the user terminal 30 is stored in the work definition data storage 207, a timing immediately before the work definition data is transferred to the robot 10, or the like.

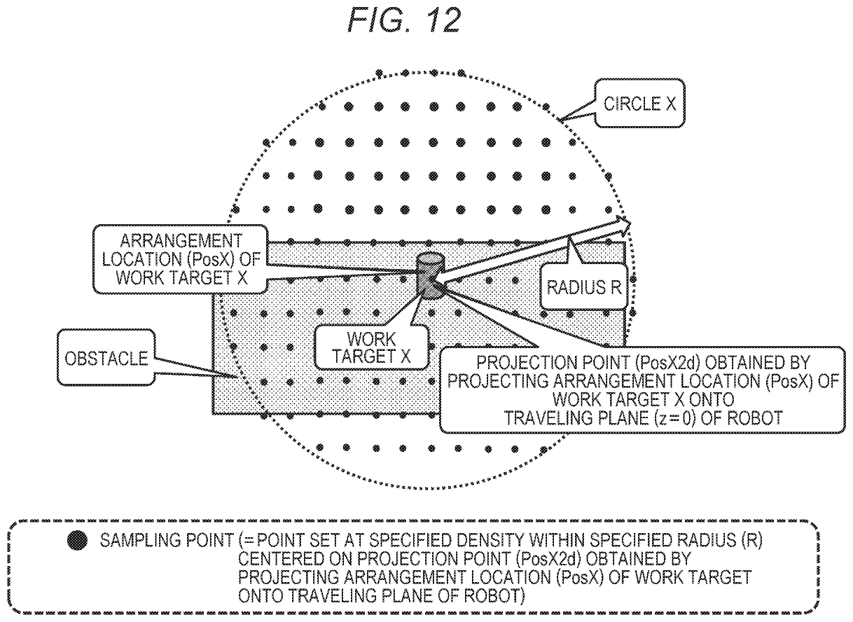

A specific example of the approach area generation processing executed by the approach area generator 205 will be described with reference to FIG. 12.

FIG. 12 is a diagram illustrating a processing example in a case where when the robot 10 executes a work motion (P) set by the user 20 on the work target object X placed on an obstacle such as a desk, the “approach area AX” which is an area where the robot 10 can safely execute the work (P) without contacting the obstacle is generated.

The location of the work target object X is denoted as PosX (XposX, YposX, ZposX), a plane on which the moving unit 11 of the robot 10 travels is denoted as z=0 plane, and a location obtained by projecting the location PosX of the work target object X onto a traveling plane (z=0) of the moving unit 11 of the robot 10 is denoted as PosX2d (XposX, YposX, 0).

A distance from a reference point (for example, in a four-wheel vehicle, the center of the axle of the rear wheel) of the moving unit 11 of the robot 10 to a location (TCP) of the hand 13 of the robot 10 when the arm 12 of the robot 10 is maximally extended is denoted as R.

A circle X that is a circle having a radius R centered on the projection location PosX2d of the location PosX of the work target object X on the robot traveling plane (z=0) is set, and a plurality of sampling points is set in the circle.

In the example illustrated in FIG. 12, the sampling points are indicated by black circles (•).

These sampling points (•) indicate, as sampling points, points set at a specified density within a specified radius (R described above) centered on a projection point (PosX2d) obtained by projecting the arrangement location (PosX) of the work target onto the traveling plane (z=0) of the robot.

In the example illustrated in FIG. 12, the approach area generator 205 determines whether or not the scheduled work on the work target X can be executed for all the sampling points (•) without interfering with (contacting) the obstacle in a state where the robot 10 is located at each sampling point in the approach area generation processing.

The approach area generator 205 selects only the sampling points at which the work is determined to be executable by this determination processing, and decides an area defined by only the selected sampling points as an approach area.

Note that, in the example illustrated in FIG. 12, the sampling points are set in a lattice pattern at regular intervals, but the sampling points may be randomly set.

Specific determination processing of each sampling point executed by the approach area generator 205 will be described.

The approach area generator 205 performs the following determination processing on each of the plurality of sampling points set in the circle X which is a circle having the radius R centered on the projection location PosX2d of the location PosX of the work target object X onto the traveling plane (z=0) of the robot.

(Determination processing 1) Whether or not the location (TCP) of the hand 13 of the robot 10 can reach a location required when the scheduled work (P) on the work target X is performed.

(Determination processing 2) Whether or not the entire robot 10 (the moving unit 11, the arm 12, and the hand 13) does not interfere with (contact) an obstacle.

In the (determination processing 1), after the robot 10 is disposed at the location of the sampling point, the posture of the robot 10 or the arm 12 at which the location (TCP) of the hand 13 of the robot 10 reaches the location of the work target is calculated by using inverse kinematics. If the posture can be calculated, it is regarded that the location (TCP) reaches the location of the work target.

In the (determination processing 2), when the robot 10 is disposed at the location of the sampling point and then the posture of the robot 10 or the arm 12 is set as calculated in the (determination processing 1), it is confirmed that there is no interference (contact) with all the surrounding obstacles. In a case where there is interference (contact), whether or not there is another posture of the robot 10 or the arm 12 in which the location (TCP) of the hand 13 of the robot 10 reaches the location of the work target without interference (contact) is calculated by using inverse kinematics.

In the (determination processing 1) and (determination processing 2) described above, the direction of the moving unit is changed on the sampling point, and the determination is performed in each direction.

After each sampling point is determined in such a manner, the approach area is generated by connecting points on an outer periphery among sampling points at which the location (TCP) of the hand 13 of the robot 10 reaches the work target and does not interfere with (contact) the obstacle.

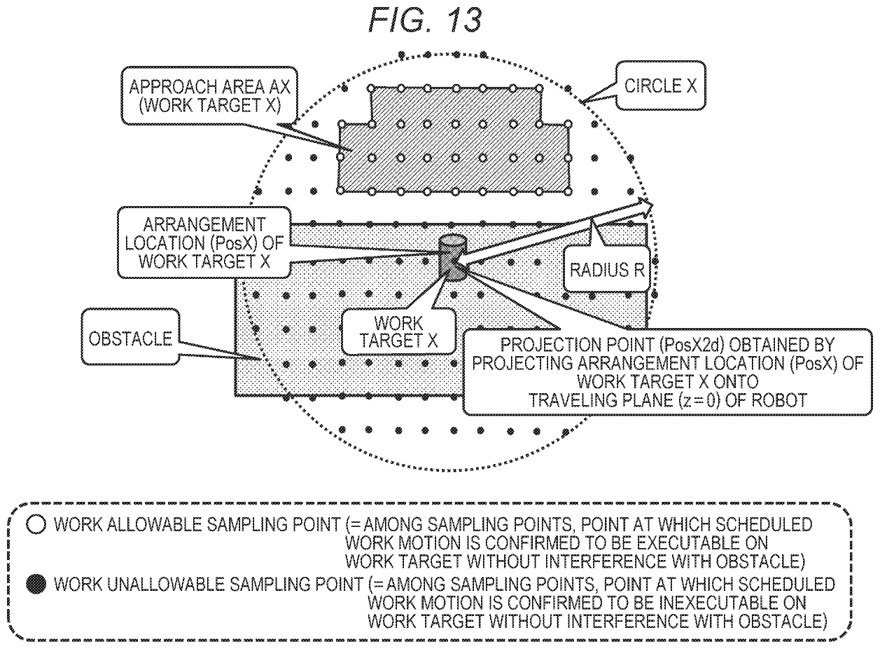

FIG. 13 illustrates an approach area decided by the determination processing of each sampling point.

Sampling points indicated by white circles (∘) are sampling points in the approach area. That is, among the sampling points, the sampling points indicated by the white circles (∘) are work allowable sampling points at which a scheduled work motion is confirmed to be executable on the work target without interference (contact) with the obstacle.

On the other hand, sampling points indicated by black circles (•) are work unallowable sampling points and sampling points outside the approach area. That is, among the sampling points, the sampling points indicated by the white black circles (•) are work unallowable sampling points at which a scheduled work motion is confirmed to be inexecutable on the work target without interference (contact) with the obstacle.

The approach area generator 205 decides the approach area by such work allowability determination processing for each sampling point.

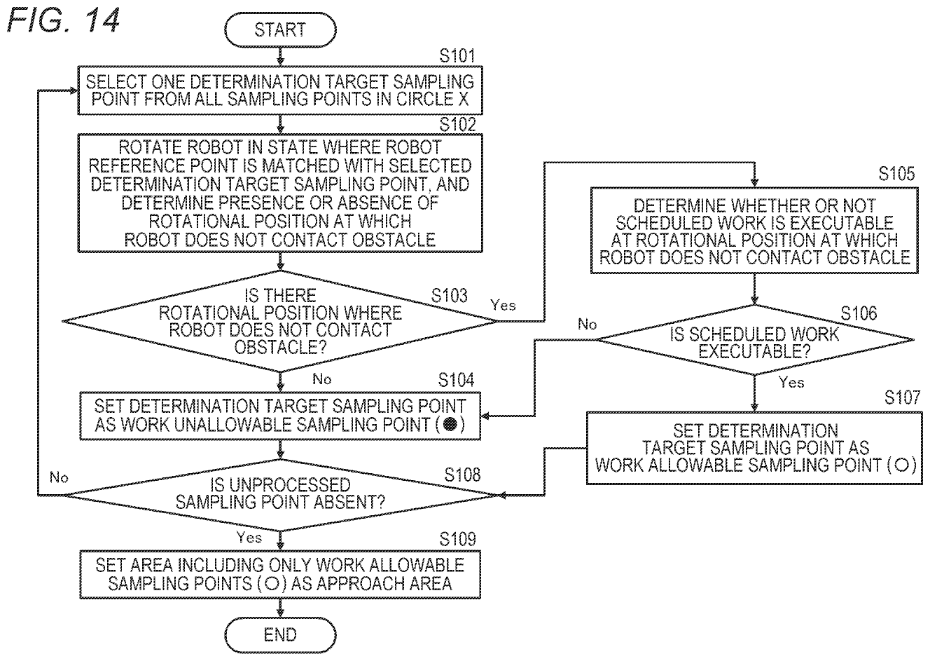

Note that a detailed example of the processing sequence of the approach area generation processing executed by the approach area generator 205 will be described later with reference to a flowchart illustrated in FIG. 14.

### (6) Generation Processing of Work Sequence Information

Next, a specific example of the generation processing of the work sequence information in the user terminal 30 will be described.

The work sequence information is the information described above with reference to FIG. 9, and is information in which the moving processing and the work to be executed by the robot 10 are arranged in time series as illustrated in FIG. 9.

The work sequence information is information in which the moving processing and work information to be executed by the robot 10 are recorded in association with sequence numbers in time series.

The user 20 sequentially inputs a work sequence desired to be performed by the robot 10 to the user terminal 30.

An example of a case where the sequence illustrated in FIG. 10 described above is set will be described.

The user 20 sequentially inputs, for example, the following motion (movement and work) of the robot 10:
move from the via-point A to the via-point B;
enter the approach area AX corresponding to the work target X and execute the scheduled work (P) on the work target X in the approach area AX;
after completion of the scheduled work (P), enter the approach area AY corresponding to the work target Y through the via-points C and D,
execute a scheduled work (Q) on the work target Y in the approach area AY; and
after completion of the scheduled work (Q), sequentially move to the via-points E, F, and G and ends.

Note that, although the work sequence information illustrated in FIG. 9 is represented in a tabular form, a language such as BASIC or a visual programming language in which blocks such as Scratch are combined may be used. In addition, control sentences such as conditional branches and other language functions may be used together.

Through the above processing, the generation of the “work definition data”, that is, the “work definition data” including the following data:
(1) predefined map;
(2) work sequence information; and
(3) work motion information
ends in the user terminal 30.

The work definition data generated in the user terminal 30 is stored in the work definition data storage 207 of the user terminal by a user operation or the like, and is transmitted from the work definition data manager 204 to the information processing device 100 of the robot 10 via the communication IF 208.

In the information processing device 100 of the robot 10, the work definition data manager 104 receives the work definition data via the communication IF 111 and the robot control unit 113, and memorizes the work definition data in the storage. As a result, the robot 10 can start the work according to the work definition data.

### 4. Processing Sequence of Approach Area Generation Processing

Next, the processing sequence of the approach area generation processing will be described.

FIG. 14 is a flowchart illustrating an example of the processing sequence of the approach area generation processing executed by the approach area generator 205 of the user terminal 30.

Note that the processing according to this flow can be executed by the approach area generator 205, which is a data processing unit of the user terminal 30, in accordance with a program stored in the storage of the user terminal 30. For example, the processing can be executed as program execution processing by a processor such as a CPU having a program execution function.

However, as described above, all the functions of the user terminal 30 described above with reference to FIG. 6 can be incorporated in the information processing device inside the robot 10. In this case, the processing according to the flow illustrated in FIG. 14 can be executed by the robot 10 alone without using the user terminal 30.

In the following description, as an example, it is assumed that the approach area generator 205 of the user terminal 30 executes processing according to the flow illustrated in FIG. 14.

Note that the flowchart illustrated in FIG. 14 illustrates a processing sequence of the determination processing of each sampling point and approach area decision processing after completion of sampling point setting processing described above with reference to FIG. 12.

That is, the flowchart is a flowchart illustrating the processing sequence of the determination processing on whether each sampling point is the work allowable sampling point (∘) in the approach area or the work unallowable sampling point (•) outside the approach area and the approach area decision processing based on the determination result.

It is assumed that the approach area generator 205 of the user terminal 30 performs the sampling point setting processing according to the processing described above with reference to FIG. 12 as preprocessing of the flow illustrated in FIG. 14.

That is, it is assumed that the processing of setting the circle X which is a circle having a radius R centered on the location PosX2d (XposX, YposX, 0) where the location PosX of the work target object X is projected onto the traveling plane (z=0) of the moving unit 11 of the robot 10, and setting a plurality of sampling points in the circle is completed.

Note that the radius R is a length corresponding to a distance R from a reference point (for example, in a four-wheel vehicle, the center of the axle of the rear wheel) of the moving unit 11 of the robot 10 to the location (TCP) of the hand 13 of the robot 10 when the arm 12 of the robot 10 is maximally extended.

Hereinafter, the processing of each step of the flow illustrated in FIG. 14 will be described.

### (Step S101)

First, in step S101, the approach area generator 205 of the user terminal 30 selects one determination target sampling point from all the sampling points in the circle X having the radius R.

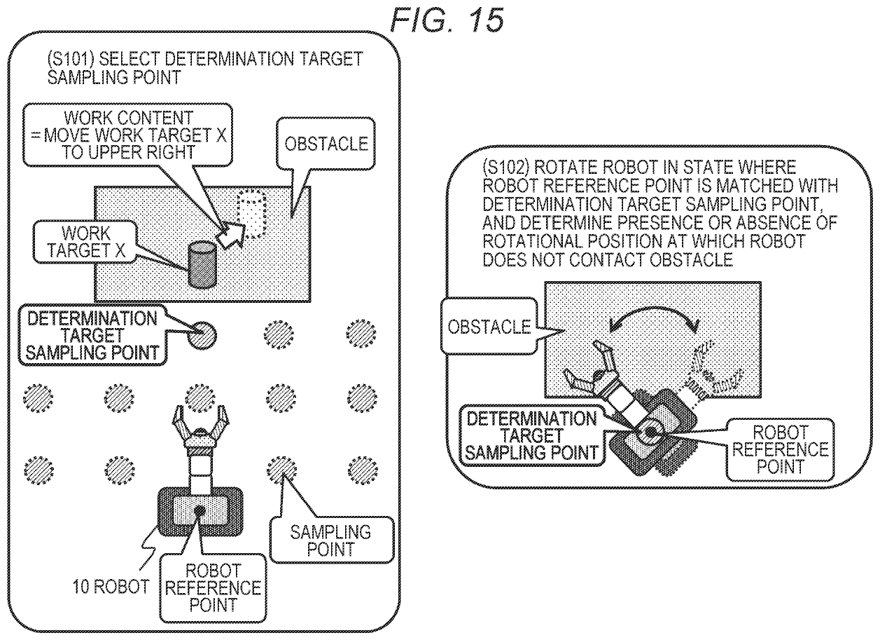

A specific example of this processing (of step S101) will be described with reference to FIG. 15.

FIG. 15 (S101) illustrates the robot 10 and the work target X placed on an obstacle such as a desk.

Note that it is assumed that the work content designated by the user is processing of moving the work target X to the upper right as illustrated in the drawing.

In the robot 10, the reference point (for example, in a four-wheel vehicle, the center of the axle of the rear wheel) is indicated by •.

First, in step S101, one determination target sampling point is selected. FIG. 15 illustrates a plurality of sampling points, and one of the sampling points is selected as a determination target sampling point.

### (Step S102)

Next, in step S102, the approach area generator 205 rotates the robot in a state where a robot reference point is matched with the selected determination target sampling point, and determines the presence or absence of a rotational position at which the robot does not contact the obstacle.

A specific example of this processing (of step S102) will be described with reference to FIG. 15.

FIG. 15 (S102) illustrates processing of rotating the robot 10 in a state where the reference point of the robot 10 is matched with the determination target sampling point selected in step S101, and determining the presence or absence of the rotational position at which the robot does not contact the obstacle.

### (Step S103)

Step S103 is a branch step based on the result of the determination processing in step S102.

In the determination processing in step S102, that is, in the determination processing as to whether or not there is a rotational position at which the robot does not contact the obstacle in a state where the robot reference point is matched with the selected determination target sampling point, in a case where the approach area generator 205 determines that there is a rotational position at which the robot does not contact the obstacle, the determination result in step S103 is Yes, and the processing proceeds to step S105.

On the other hand, in a case where it is determined that there is not a rotational position where the robot does not contact the obstacle, the determination result of step S103 is No, and the processing proceeds to step S104.

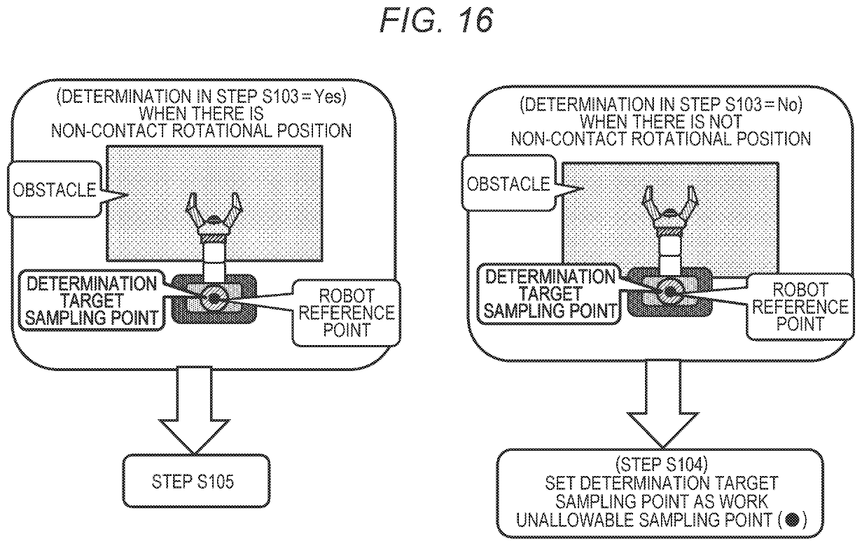

A specific example of the processing (of step S103) will be described with reference to FIG. 16.

FIG. 16 illustrates two specific examples:
(determination in step S103=Yes) when there is a non-contact rotational position; and
(determination in step S103=No) when there is not a non-contact rotational position.

The example of (determination in step S103=Yes) when there is a non-contact rotational position is an example in which a rotational position at which the robot does not contact the obstacle in a state where the robot reference point is matched with the determination target sampling point is detected.

In such a case, the determination result in step S103 is Yes, and the processing proceeds to step S105.

On the other hand, the example of (determination in step S103=No) when there is not a non-contact rotational position is an example of a case where a rotational position at which the robot does not contact the obstacle in a state where the robot reference point is matched with the determination target sampling point cannot be detected.

In such a case, the determination result in step S103 is No, and the processing proceeds to step S104.

### (Step S104)

The processing in step S104 is executed in a case where the determination in step S103 is No, that is, in a case where a rotational position at which the robot does not contact the obstacle is not detected in a state where the robot reference point is matched with the determination target sampling point.

In this case, in step S104, the approach area generator 205 sets the determination target sampling point as a work unallowable sampling point, that is, a sampling point outside the approach area.

### (Step S105)

The processing in step S105 is executed in a case where the determination in step S103 is Yes, that is, in a case where a rotational position at which the robot does not contact the obstacle is detected in a state where the robot reference point is matched with the determination target sampling point.

In this case, in step S105, the approach area generator 205 determines whether or not the scheduled work is executable at the rotational position at which the robot does not contact the obstacle.

Note that the scheduled work is acquired from the work motion information input by the user 20.

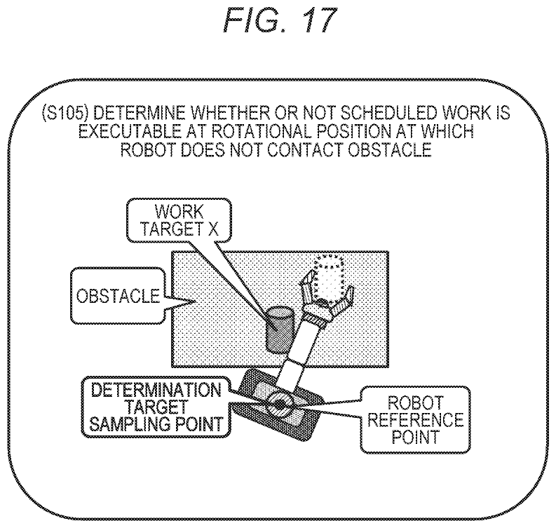

A specific example of this processing (of step S105) will be described with reference to FIG. 17.

In this processing example, it is assumed that a work instruction input by the user is processing of moving the work target X to the upper right as illustrated in FIG. 17.

In this case, in step S105, the approach area generator 205 determines whether or not this work is executable at the rotational position at which the robot does not contact the obstacle.

### (Step S106)

Step S106 is a branch step based on the result of the determination processing in step S105.

In the determination processing in step S105, that is, the determination processing as to whether or not the scheduled work is executable at the rotational position at which the robot does not contact the obstacle, in a case where the approach area generator 205 determines that the scheduled work is executable, the determination result in step S106 is Yes, and the processing proceeds to step S107.

On the other hand, in a case where it is determined that the scheduled work is inexecutable, the determination result of step S106 is No, and the processing proceeds to step S104.

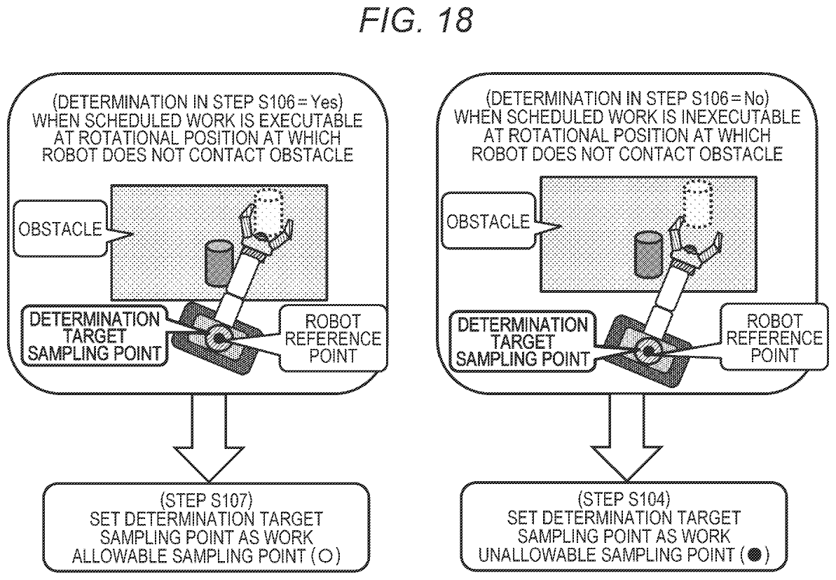

A specific example of this processing (of step S106) will be described with reference to FIG. 18.

FIG. 18 illustrates the following two specific examples:
(determination in step S106=Yes) when the scheduled work is executable at the rotation position of the robot that does not contact the obstacle; and
(determination in step S106=No) when the scheduled work is inexecutable at the rotational position at which the robot does not contact the obstacle.

The example of (determination in step S106=Yes) when the scheduled work is executable at the rotational position at which the robot does not contact the obstacle is an example in which the robot reference point is matched with the determination target sampling point, and the scheduled work is confirmed to be executable at the rotational position at which the robot does not contact the obstacle.

In such a case, the determination result in step S106 is Yes, and the processing proceeds to step S107.

On the other hand, the example of (determination in step S106=No) when the scheduled work is inexecutable at the rotational position at which the robot does not contact the obstacle is an example in which the robot reference point is matched with the determination target sampling point, and the scheduled work is confirmed to be inexecutable at the rotational position at which the robot does not contact the obstacle.

In such a case, the determination result in step S106 is No, and the processing proceeds to step S104.

### (Step S104)

Here, step S104 will be described again.

The processing in step S104 is executed both in a case where the determination in step S103 is Yes and in a case where the determination in step S106 is No.

That is, the processing is also executed in a case where a rotational position at which the robot does not contact the obstacle is detected in step S103 in a state where the robot reference point is matched with the determination target sampling point, but it is determined in step S106 that the scheduled work is inexecutable at the rotational position at which the robot does not contact the obstacle.

In this case, in step S104, the approach area generator 205 sets the determination target sampling point as a work unallowable sampling point, that is, a sampling point outside the approach area.

### (Step S107)

On the other hand, the processing in step S107 is executed in a case where the determination in step S106 is Yes, that is, in a case where it is determined that the scheduled work is executable at the rotational position at which the robot does not contact the obstacle.

In this case, in step S107, the approach area generator 205 sets the determination target sampling point as a work allowable sampling point, that is, a sampling point in the approach area.

### (Step S108)

In a case where any of the processing of step S104, that is, the processing of setting the determination target sampling point as the work unallowable sampling point, that is, the sampling point outside the approach area, or the processing of step S107, that is, the processing of setting the determination target sampling point as the work allowable sampling point, that is, the sampling point in the approach area is completed, the processing of step S108 is executed.

In any of these cases, in step S108, the approach area generator 205 determines whether or not an unprocessed sampling point, that is, a sampling point for which the determination processing is not completed remains.

In a case where there is an unprocessed sampling point, the processing returns to step S101, and processing of the unprocessed sampling point is executed.

On the other hand, in a case where there is no unprocessed sampling point, the processing proceeds to step S109.

### (Step S109)

When the determination processing of all the sampling points is completed, the approach area generator 205 sets an area including only the work allowable sampling points as the approach area in step S109.

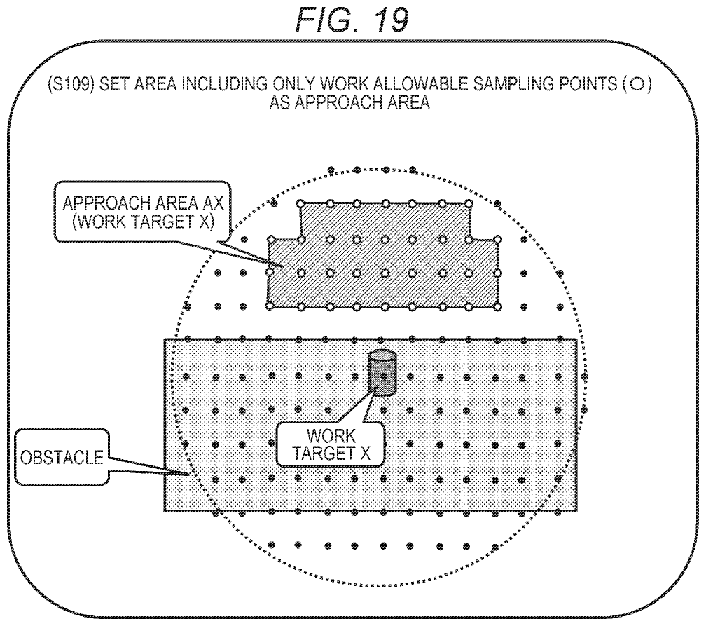

A specific example of this processing (of step S109) will be described with reference to FIG. 19.

FIG. 19 illustrates an approach area decides by the determination processing of each sampling point in the circle X having the radius R.

Sampling points indicated by white circles (∘) are sampling points in the approach area. That is, among the sampling points, the sampling points indicated by the white circles (∘) are work allowable sampling points at which a scheduled work motion is confirmed to be executable on the work target without interference (contact) with the obstacle.

On the other hand, sampling points indicated by black circles (•) are work unallowable sampling points and sampling points outside the approach area. That is, among the sampling points, the sampling points indicated by the white black circles (•) are work unallowable sampling points at which a scheduled work motion is confirmed to be inexecutable on the work target without interference (contact) with the obstacle.

The approach area generator 205 decides the approach area by such work allowability determination processing for each sampling point.

If the reference point of the robot 10 is in the approach area AX illustrated in FIG. 19, it is possible to execute the scheduled work on the work target X, that is, the processing according to the work motion information input by the user without causing contact or interference (contact) with the obstacle.

In a case where there is a plurality of work target objects, the approach area generator 205 executes the processing according to the flow described with reference to FIG. 14 for each of the work target objects. That is, approach area generation processing by the work allowability determination processing for each sampling point is executed.

For example, in a case of causing the robot 10 to perform a motion according to the “sequence information” illustrated in FIG. 9 described above, a motion image of the robot according to this work sequence is as illustrated in FIG. 10.

In a motion sequence illustrated in FIG. 10, there are two work targets X and Y, and processing according to the flow described with reference to FIG. 14 is executed for each of the two work targets X and Y to generate an approach area.

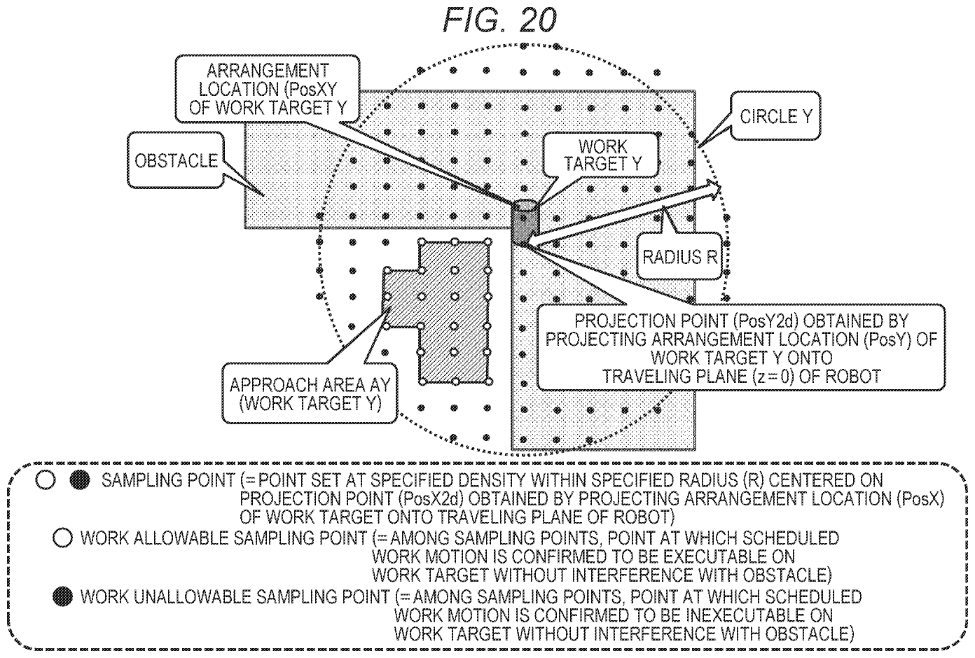

FIG. 20 illustrates an example of setting the approach area corresponding to the work target Y illustrated in FIG. 10.

FIG. 20 illustrates an approach area decides by determination processing of each sampling point in a circle Y having the radius R centered on a projection point (PosY2d) obtained by projecting an arrangement location (PosY) of the work target Y onto the traveling plane (z=0) of the robot.

Sampling points indicated by white circles (∘) are sampling points in the approach area. That is, the sampling points indicated by the white circles (∘) are work allowable sampling points at which a scheduled work motion is confirmed to be executable on the work target without interference (contact) with the obstacle by executing the processing according to the flow described with reference to FIG. 14.

On the other hand, sampling points indicated by black circles (•) are work unallowable sampling points and sampling points outside the approach area. These sampling points are work unallowable sampling points at which a scheduled work motion is confirmed to be inexecutable on the work target without interference (contact) with the obstacle by executing the processing according to the flow described with reference to FIG. 14.

The approach area generator 205 decides the approach area by such work allowability determination processing for each sampling point.

If the reference point of the robot 10 is in the approach area AY illustrated in FIG. 20, it is possible to execute the scheduled work on the work target Y, that is, the processing according to the work motion information input by the user without causing contact or interference (contact) with the obstacle.

### 5. Details of Motion of Robot Based on Work Definition Data

Next, the motion of the robot based on the work definition data will be described in detail.

As described above, the “work definition data”, that is, the “work definition data” including the following data:
(1) predefined map;
(2) work sequence information; and
(3) work motion information
is generated in the user terminal 30.

The work definition data generated in the user terminal 30 is stored in the work definition data storage 207 of the user terminal by a user operation or the like, and is transmitted from the work definition data manager 204 to the information processing device 100 of the robot 10 via the communication IF 208.

In the information processing device 100 of the robot 10, the work definition data manager 104 receives the work definition data via the communication IF 111 and the robot control unit 113, and memorizes the work definition data in the storage. As a result, the robot 10 can start the work according to the work definition data.

The motion of the robot 10 according to the work definition data will be described in detail below.

First, a flow until the robot 10 starts a work in response to an operation by the user 20 will be described.

First, the user 20 inputs the “work definition data” to be applied to the work to be executed by the robot 10 to the information processing device 100 of the robot 10.

The input processing of the “work definition data” to the information processing device 100 of the robot 10 is input via the robot operation UI 112 of the information processing device 100 having the configuration illustrated in FIG. 3 attached to the robot 10.

Alternatively, the user terminal 30 having the configuration illustrated in FIG. 6 is operated to perform input from the communication IF 208 of the user terminal 30 via the communication IF 111 of the information processing device 100 of the robot 10.

Hereinafter, a processing example will be described in a case where the “work sequence information” described above with reference to FIG. 9 is included in the “work definition data” input to the information processing device 100 of the robot 10, and the robot 10 performs a motion according to the “work sequence information” illustrated in FIG. 9.

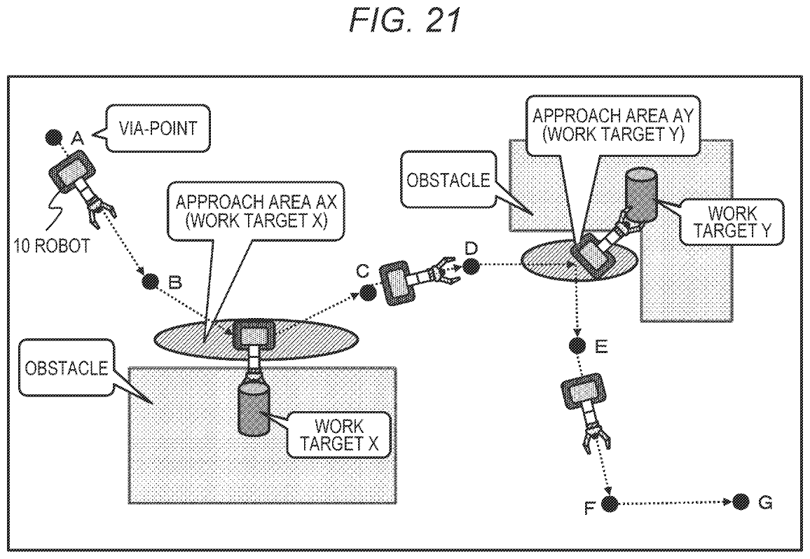

That it, a motion image of the robot according to the work sequence is illustrated in FIG. 21.

As illustrated in FIG. 21, the robot 10 moves from the via-point A to the via-point B and enters the approach area AX corresponding to the work target X. Thereafter, the robot 10 executes a scheduled work (P) on the work target X in the approach area AX. After completion of the scheduled work (P), the robot 10 enters the approach area AY corresponding to the work target Y through the via-points C and D. Thereafter, the robot 10 executes a scheduled work (Q) on the work target Y in the approach area AY. After completion of the scheduled work (Q), the robot 10 sequentially moved to the via-points E, F, and G and ends the sequence.

It is assumed that the robot 10 is initially at the point A in FIG. 21.

The user 20 performs an operation of instructing a start of a work via the robot operation UI 112 of the main body of the robot 10 or the user terminal 30, and then, a work start instruction is input to the robot control unit 113 of the information processing device 100 of the robot 10.

Note that information (name, ID, and the like of the work definition data) indicating work definition data used for work may be added to the work start instruction input to the robot control unit 113.

In addition, separately from the work start instruction, information specifying work definition data to be used may be transmitted in advance from the robot operation UI 112 or the user terminal 30 to the robot control unit 113.

The robot control unit 113 that has received the work start instruction requests the work definition data manager 104 to read the “work definition data” designated by the user 20.

The work definition data manager 104 reads the “work definition data” designated by the user 20 from the storage in the information processing device 100.

Note that, as described above, the “work definition data” includes each of the following data:
(1) predefined map;
(2) work sequence information; and
(3) work motion information.

The work definition data manager 104 outputs a predefined map (map data) in the read “work definition data” to the predefined map manager 105.

Furthermore, the work sequence information and the work motion information are output to the sequence control unit 114.

After these processing, the robot 10 can start moving according to the “work definition data”.

Next, processing using the sensor detection information input from the sensor 101 while the robot 10 is performing the work will be described.

After starting the motion according to the “work definition data” input by the user 20, the robot 10 continuously executes obstacle detection processing in the travel environment of the robot by using the sensor 101.

As described above with reference to FIG. 3, the sensor 101 is a sensor for detecting the surrounding environment such as an obstacle around the robot, and includes, for example, a camera, light detection and ranging (LiDAR), and the like.

The obstacle map creator 103 analyzes a distance from the robot 10 to each obstacle, a relative positional relationship, and the shape of the obstacle on the basis of the detection information of the sensor 101, and further generates an “obstacle map” by using self-location information estimated by the self-location estimator 102.

As described above with reference to FIG. 5(2a), the “obstacle map” is a map indicating the arrangement locations of obstacles existing around the robot 10, and is a map including the latest obstacle information around the robot 10.

The obstacle map creator 103 creates an “obstacle map” such as an occupancy grid map, for example.

As described above, the occupancy grid map (grid map) is a map in which a probability value of presence of an obstacle in each section (grid) defined by a lattice is set. There is also a map in which each of the sections (grids) is classified into “occupied”, “vacant”, “unknown”, and the like.

The robot 10 can travel safely without colliding with an obstacle by selecting, as a traveling route, a section (grid) in which the probability of the presence of an obstacle is low, among sections of the occupancy grid map (grid map) and traveling in the section.

The “obstacle map” generated by the obstacle map creator 103 is input to the differential obstacle detector 106.

The differential obstacle detector 106 compares the “obstacle map” generated by the obstacle map creator 103 with the “predefined map” included in the “work definition data” designated by the user 20, and detects a difference between the two maps.

Specifically, for example, a differential obstacle (new obstacle) that exists in the “obstacle map” generated by the obstacle map creator 103 but does not exist in the “predefined map” is detected.

As described above with reference to FIGS. 4 and 5, the “predefined map” described with reference to FIG. 4(1a) is a map created before the robot 10 travels, whereas the “obstacle map” illustrated in FIG. 5(2a) is a map reflecting the latest obstacle location created on the basis of the information acquired by the sensor of the robot 10.

There is a possibility that the “obstacle map” illustrated in FIG. 5(2a) includes a “differential obstacle” which is a new obstacle not included in the “predefined map” described above with reference to FIG. 4(1a).

The “differential obstacle” is an obstacle not existing at the time of creating the “predefined map”, and is an obstacle newly detected at the time of creating the “obstacle map”.

In the processing of comparing the two maps, the differential obstacle detector 106 first arranges, for example, an AR marker or the like at a key point (for example, the via-point A or the like), and the self-location estimator 102 detects the AR marker or the like to aligning the “predefined map” and the “obstacle map”.

Furthermore, after the “predefined map” and the “obstacle map” are aligned, the presence or absence of an obstacle is compared between corresponding locations on the respective maps. In a case where there is no obstacle on the “predefined map” and there is an obstacle on the “obstacle map”, the obstacle is determined as a “differential obstacle (new obstacle)” that has occurred after generation of the “predefined map”.

The differential obstacle detector 106 outputs the detected differential obstacle information to the approach area corrector 107.

The approach area corrector 107 inputs each of the following information:
(a) the “predefined map” from the predefined map manager 105; and
(b) “differential obstacle” information which is a new obstacle not existing on the “predefined map” detected by the differential obstacle detector 106.

The approach area corrector 107 uses the above input information to perform correction processing of the “preset approach area” defined on the “predefined map”.

Specifically, a “corrected approach area” is generated in consideration of the “differential obstacle” which is a new obstacle not existing on the “predefined map” detected by the differential obstacle detector 106.

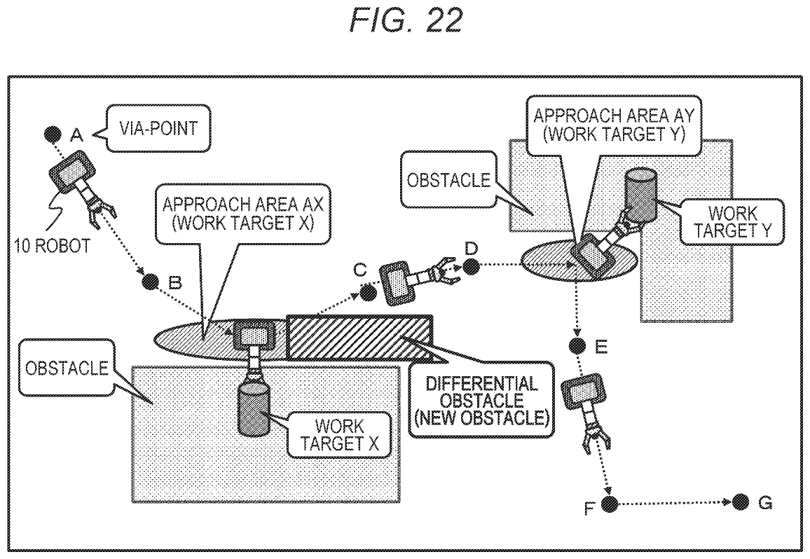

That is, for example, in a case where a “differential obstacle (new obstacle)” as illustrated in FIG. 22 is detected, a part of the “approach area AX” which is a preset approach area already set on the “predefined map” is an area where the robot 10 cannot execute the work on the work target X without contacting the obstacle.

That is, the “approach area AX” which is a preset approach area already set on the “predefined map” is an approach area set without considering the “differential obstacle (new obstacle)”.

The approach area corrector 107 corrects the preset approach area already set on such a “predefined map”, and generates a “corrected approach area” in consideration of the “differential obstacle”.

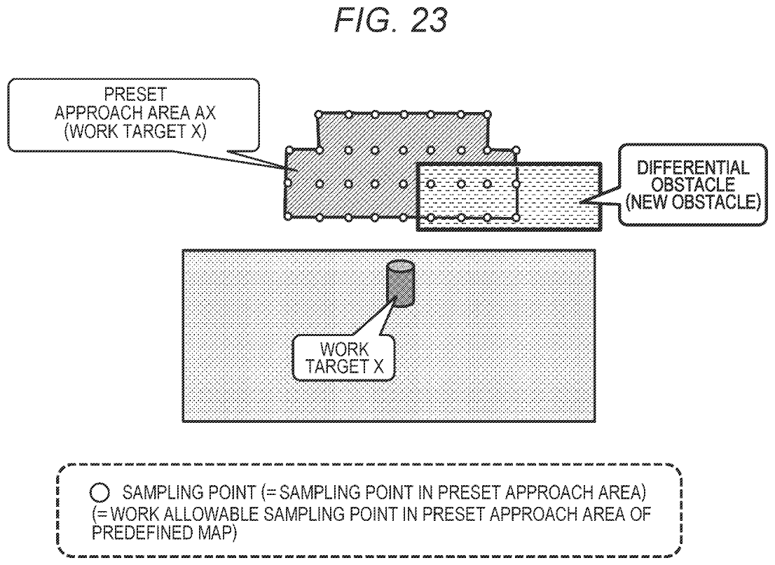

A specific example of the correction of the approach area executed by the approach area corrector 107 will be described with reference to FIG. 23.

First, sampling points are set in the “preset approach area” already set on the “predefined map”. For example, the sampling points are set at equal intervals in the “preset approach area”.

Note that the sampling points (work allowable sampling points) used when the “preset approach area” described above with reference to the flows of FIGS. 12, 13, and 14 is generated may be used as they are.

A new sampling point may be set.

The approach area corrector 107 checks whether or not interference (contact) with a differential obstacle (new obstacle) occurs in a case where the robot 10 performs a scheduled work on the work target for each sampling point set in the “preset approach area”.

Specifically, it is confirmed for each sampling point that the entire robot (the moving unit, the robot arm, and the like) does not interfere with (contact) the differential obstacle.

For example, the following determination processing is executed.

(Determination processing 1) Whether or not the location (TCP) of the hand 13 of the robot 10 can reach a location required when the scheduled work (P) on the work target X is performed.

(Determination processing 2) Whether or not the entire robot 10 (the moving unit 11, the arm 12, and the hand 13) does not interfere with (contact) the differential obstacle (new obstacle).

In the (determination processing 1), after the robot 10 is disposed at the location of the sampling point, the posture of the robot 10 or the arm 12 at which the location (TCP) of the hand 13 of the robot 10 reaches the location of the work target is calculated by using inverse kinematics. If the posture can be calculated, it is regarded that the location (TCP) reaches the location of the work target.

In the (determination processing 2), when the robot 10 is disposed at the location of the sampling point and then the posture of the robot 10 or the arm 12 is set as calculated in the (determination processing 1), it is confirmed that there is no interference (contact) with the surrounding differential obstacle (new obstacle). In a case where there is interference (contact), whether or not there is another posture of the robot 10 or the arm 12 in which the location (TCP) of the hand 13 of the robot 10 reaches the location of the work target without interference (contact) is calculated by using inverse kinematics.

In the (determination processing 1) and (determination processing 2) described above, the direction of the moving unit is changed on the sampling point, and the determination is performed in each direction.

After each sampling point is determined in such a manner, the corrected approach area is generated by connecting points on the outer periphery among sampling points at which the location (TCP) of the hand 13 of the robot 10 reaches the work target and does not interfere with (contact) the differential obstacle (new obstacle).

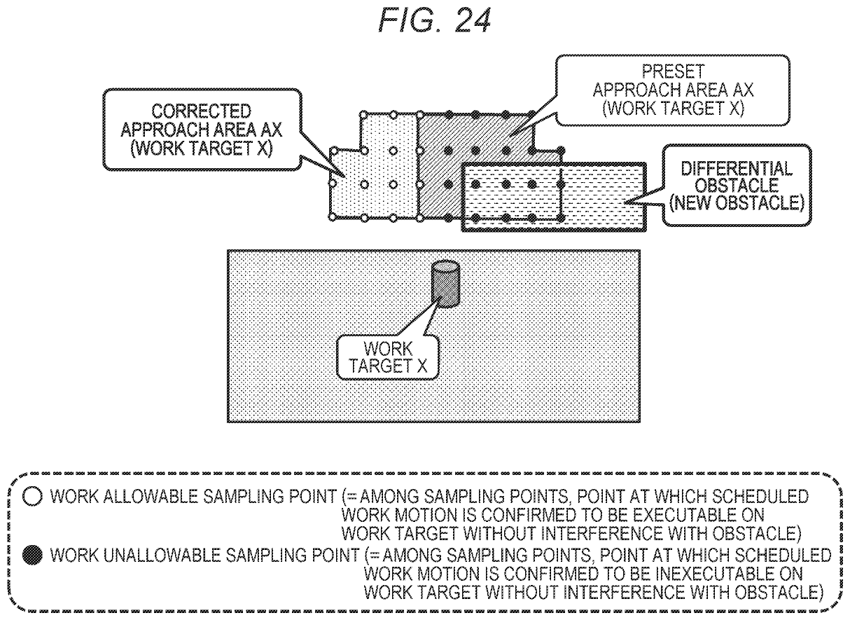

FIG. 24 illustrates the corrected approach area decided by the determination processing of each sampling point set in the “preset approach area”.

Sampling points indicated by white circles (∘) are sampling points in the corrected approach area. That is, among the sampling points set in the “preset approach area”, the sampling points indicated by the white circles (∘) are work allowable sampling points at which a scheduled work motion is confirmed to be executable on the work target without interference (contact) with the differential obstacle (new obstacle).

On the other hand, sampling points indicated by black circles (•) are work unallowable sampling points. These points are points that have been originally work allowable sampling points in the preset approach area but have been found to interfere with (contact) the differential obstacle (new obstacle) and have been changed to work unallowable sampling points. These points are sampling points outside the corrected approach area.

The approach area corrector 107 decides the corrected approach area by such work allowability determination processing for each sampling point.

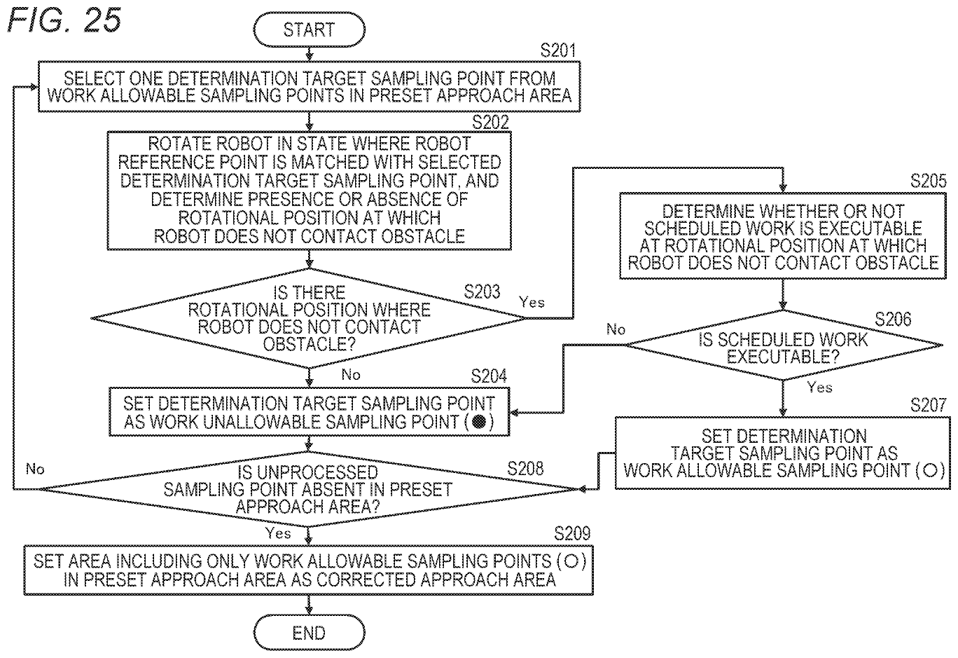

Note that a detailed example of a processing sequence of approach area correction processing executed by the approach area corrector 107 will be described later with reference to a flowchart illustrated in FIG. 25.

Note that the approach area corrector 107 may correct the approach area not only for the preset approach area on the predefined map but also for the corrected approach area generated by the approach area corrector 107 itself of the information processing device 100 of the robot 10 during the previous travel.

In this case, the new differential obstacle input from the differential obstacle detector 106 is marked with a sampling point in the corrected approach area generated last time, interference (contact) with the new differential obstacle is confirmed, and the corrected approach area generated last time is further corrected.

That is, the approach area corrector 107 executes processing of generating a re-corrected approach area obtained by re-correcting a generated corrected approach area that has been generated in the approach area correction processing executed in the past in consideration of a differential obstacle that has newly occurred.

In this case, the approach area corrector 107 determines whether or not the sampling point set inside the generated corrected approach area allows the robot 10 to work without contacting the differential obstacle that has newly occurred, and generates the re-corrected approach area.

As described above, the approach area corrector 107 sets sampling points only in the preset approach area already set in the predefined map or the like, performs interference (contact) determination with the differential obstacle for the limited sampling points, and generates a new corrected approach area in the preset approach area.

By performing the interference (contact) determination of the sampling points in such a limited area, the processing can be efficiently performed in a short time as compared with the processing for a large number of sampling points in a wide area as described above with reference to FIGS. 12 to 14.

In the processing described above with reference to FIGS. 12 to 14, it is necessary to perform the interference (contact) determination for each of the large number of sampling points set in the circle (circle X) having the radius R centered on the projection location PosX2d of the location PosX of the work target object X onto the robot traveling plane (z=0), and thus the processing takes time.

On the other hand, as described with reference to FIGS. 23 and 24, the approach area corrector 107 sets sampling points only in the preset approach area already set in the predefined map or the like, performs the interference (contact) determination with the differential obstacle for the limited sampling points, and generates a new corrected approach area in the preset approach area, and thus, the processing can be efficiently performed in a short time.

The environment map integrator 108 inputs each of the following information:
(a) the “predefined map” from the predefined map manager 105;
(b) the “obstacle map” from the obstacle map creator 103; and
(c) “corrected approach area information” and “differential obstacle information” from the approach area corrector 107.

The environment map integrator 108 creates an “integrated environment map” by using the above input information.

That is, the “integrated environment map” is created in which the latest location of the obstacle and the “corrected approach area” obtained by correcting the “preset approach area” recorded in the “predefined map” on the basis of the latest location of the obstacle are recorded.

The “integrated environment map” generated by the environment map integrator 108 is a map having each of the following information.

The obstacle information of both obstacle information of the “predefined map” and the “obstacle map”.

The approach area information=a corrected approach area for a corrected preset approach area, and a preset approach area that is not corrected remains.

In addition, the information of the predefined map is directly inherited as each information of the location and area of the work target and the via-point.

### 6. Processing Sequence of Approach Area Correction Processing Executed by Approach Area Corrector of Information Processing Device of Robot

Next, the processing sequence of the approach area correction processing executed by the approach area corrector 107 of the information processing device 100 of the robot 10 will be described.

FIG. 25 is a flowchart illustrating an example of the processing sequence of the approach area correction processing executed by the approach area corrector 107 of the information processing device 100 of the robot 10.

Note that the processing according to this flow can be executed by the approach area corrector 107 of the information processing device 100 of the robot 10 in accordance with a program stored in the storage of the information processing device 100. For example, the processing can be executed as program execution processing by a processor such as a CPU having a program execution function.

Note that the flowchart illustrated in FIG. 25 illustrates a processing sequence of the determination processing of each sampling point and approach area decision processing after completion of the sampling point setting processing for the preset approach area described above with reference to FIG. 23.

As described above with reference to FIG. 23, the approach area corrector 107 of the information processing device 100 of the robot 10 first sets sampling points in the “preset approach area” already set on the “predefined map” generated in advance. For example, the sampling points are set at equal intervals in the “preset approach area”.

Note that, as described above, the sampling points (the work allowable sampling points in the preset approach area illustrated in FIG. 13) set at the time of generating the “preset approach area” may be used as they are.

The flowchart illustrated in FIG. 25 is a flowchart illustrating the processing sequence of the determination processing on whether the sampling point in the preset approach area set in this manner is the work allowable sampling point (∘) that allows the scheduled work without interfering (contacting) with the differential obstacle (new obstacle) or the work unallowable sampling point (•) that dosed not allow the scheduled work, and corrected approach area decision processing based on the determination result.

Hereinafter, the processing of each step of the flow illustrated in FIG. 25 will be described.

### (Step S201)

First, in step S201, the approach area corrector 107 of the information processing device 100 of the robot 10 selects one determination target sampling point from the sampling points in the “preset approach area” already set on the “predefined map” generated in advance.

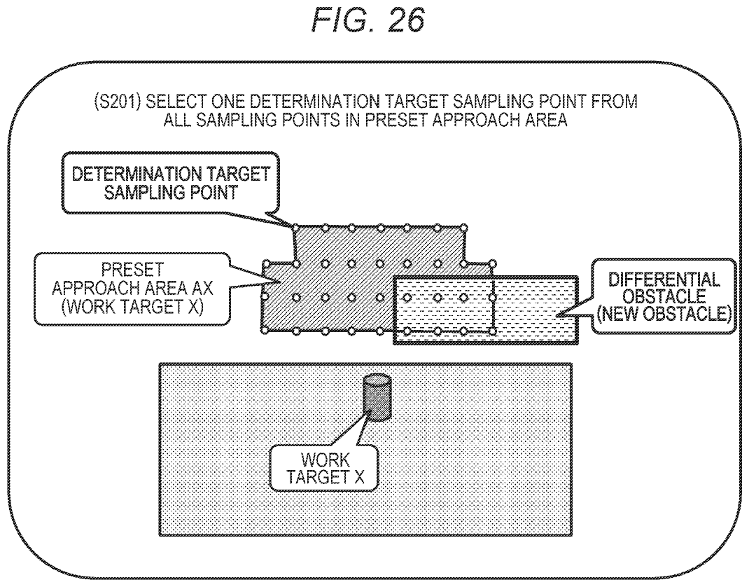

A specific example of the processing (of step S201) will be described with reference to FIG. 26.

FIG. 26 (S201) illustrates the work target X placed on an obstacle such as a desk, the “preset approach area” set before the work target X, and the differential obstacle (new obstacle).

The “preset approach area” is a “preset approach area” already set on the “predefined map” generated in advance, and a plurality of sampling points has been already set in the preset approach area.

First, in step S201, one determination target sampling point is selected from the sampling points in the “preset approach area”. FIG. 26 illustrates the plurality of sampling points in the “preset approach area”, and one of the sampling points is selected as the determination target sampling point.

### (Step S202)

Next, in step S202, the approach area corrector 107 rotates the robot in a state where the robot reference point is matched with the selected determination target sampling point, and determines the presence or absence of the rotational position at which the robot does not contact the obstacle.

Note that, here, only the differential obstacle (new obstacle) is only required to be determined as a determination target of contact possibility. This is because it has already been confirmed that the scheduled work can be performed without contact with the existing obstacle at the time of generating the “preset approach area”.

### (Step S203)

Step S203 is a branch step based on the result of the determination processing in step S202.

In the determination processing in step S202, that is, in the determination processing as to whether or not there is a rotational position at which the robot does not contact the obstacle in a state where the robot reference point is matched with the selected determination target sampling point, in a case where the approach area corrector 107 determines that there is a rotational position at which the robot does not contact the obstacle, the determination result in step S203 is Yes, and the processing proceeds to step S205.

On the other hand, in a case where it is determined that there is not a rotational position where the robot does not contact the obstacle, the determination result of step S203 is No, and the processing proceeds to step S204.

### (Step S204)

The processing in step S204 is executed in a case where the determination in step S203 is No, that is, in a case where a rotational position at which the robot does not contact the obstacle is not detected in a state where the robot reference point is matched with the determination target sampling point.

In this case, in step S204, the approach area corrector 107 sets the determination target sampling point as a work unallowable sampling point, that is, a sampling point outside the corrected approach area.

### (Step S205)

The processing in step S205 is executed in a case where the determination in step S203 is Yes, that is, in a case where a rotational position at which the robot does not contact the obstacle is detected in a state where the robot reference point is matched with the determination target sampling point.

In this case, in step S205, the approach area corrector 107 determines whether or not the scheduled work is executable at the rotational position at which the robot does not contact the obstacle.

Note that the scheduled work is acquired from the work motion information input by the user 20.

### (Step S206)

Step S206 is a branch step based on the result of the determination processing in step S205.

In the determination processing in step S205, that is, the determination processing as to whether or not the scheduled work is executable at the rotational position at which the robot does not contact the obstacle, in a case where the approach area corrector 107 determines that the scheduled work is executable, the determination result in step S206 is Yes, and the processing proceeds to step S207.

On the other hand, in a case where it is determined that the scheduled work is inexecutable, the determination result of step S206 is No, and the processing proceeds to step S204.

### (Step S204)

Here, step S204 will be described again.

The processing in step S204 is executed both in a case where the determination in step S203 is Yes and in a case where the determination in step S206 is No.

That is, the processing is also executed in a case where a rotational position at which the robot does not contact the obstacle is detected in step S203 in a state where the robot reference point is matched with the determination target sampling point, but it is determined in step S206 that the scheduled work is inexecutable at the rotational position at which the robot does not contact the obstacle.

In this case, in step S204, the approach area corrector 107 sets the determination target sampling point as a work unallowable sampling point, that is, a sampling point outside the corrected approach area.

### (Step S207)

On the other hand, the processing in step S207 is executed in a case where the determination in step S206 is Yes, that is, in a case where it is determined that the scheduled work is executable at the rotational position at which the robot does not contact the obstacle.

In this case, in step S207, the approach area corrector 107 sets the determination target sampling point as a work allowable sampling point, that is, a sampling point inside the corrected approach area.

### (Step S208)

In a case where any of the processing of step S204, that is, the processing of setting the determination target sampling point as the work unallowable sampling point, that is, the sampling point outside the corrected approach area, or the processing of step S207, that is, the processing of setting the determination target sampling point as the work allowable sampling point, that is, the sampling point in the corrected approach area is completed, the processing of step S208 is executed.

In any of these cases, in step S208, the approach area corrector 107 determines whether or not an unprocessed sampling point, that is, a sampling point for which the determination processing is not completed remains.

In a case where there is an unprocessed sampling point, the processing returns to step S201, and processing of the unprocessed sampling point is executed.

On the other hand, in a case where there is no unprocessed sampling point, the processing proceeds to step S209.

### (Step S209)

When the determination processing of all the sampling points is completed, the approach area corrector 107 sets an area including only the work allowable sampling points as the corrected approach area in step S209.

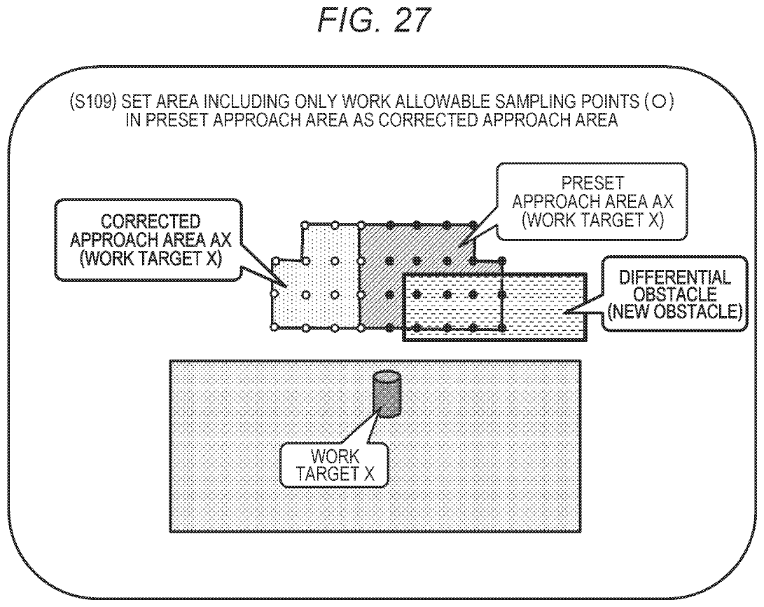

A specific example of this processing (of step S209) will be described with reference to FIG. 27.

FIG. 27 illustrates the work target X placed on an obstacle such as a desk, the “preset approach area” set before the work target X, the differential obstacle (new obstacle), and a “corrected approach area AX” decided in accordance with the flow illustrated in FIG. 25.

The “preset approach area” illustrated in FIG. 27 is a “preset approach area” already set on the “predefined map” generated in advance. A determination processing according to the flow illustrated in FIG. 25 is performed on a plurality of sampling points among the sampling points, and a “corrected approach area AX” is decided.

Sampling points indicated by white circles (∘) are sampling points in the corrected approach area. That is, among the sampling points, the sampling points indicated by the white circles (∘) are work allowable sampling points at which a scheduled work motion is confirmed to be executable on the work target without interference (contact) with all the obstacles including the differential obstacle (new obstacle).

On the other hand, sampling points indicated by black circles (•) are work unallowable sampling points and sampling points outside the corrected approach area. These sampling points are sampling points in the “preset approach area” already set on the “predefined map”, and are new work unallowable sampling points at which it has been confirmed that a scheduled work motion is executable without contact with an existing obstacle existing at the time of generating the “preset approach area”, but a scheduled work motion is inexecutable on a work target without interference (contact) with a differential obstacle (new obstacle).

As described above, the approach area corrector 107 determines the corrected approach area by the work allowability determination processing for each sampling point in the preset approach area.

If the reference point of the robot 10 is in the corrected approach area AX illustrated in FIG. 27, it is possible to execute the scheduled work on the work target X, that is, the processing according to the work motion information input by the user without causing contact or interference (contact) with the obstacle.

In a case where there is a plurality of “preset approach areas” on the “predefined map”, the approach area corrector 107 executes processing according to the flow described with reference to FIG. 25 for each of the “preset approach areas”.

### 7. Work Sequence by Robot Using Environment Map Reflecting Corrected Approach Area Generated by Information Processing Device of Robot

Next, the work sequence by the robot using the “integrated environment map” reflecting the corrected approach area generated by the information processing device of the robot will be described.

As described above, the approach area corrector 107 performs correction processing of the “preset approach area” defined on the “predefined map”, and generates the “corrected approach area” in consideration of the “differential obstacle (new obstacle)” which is a new obstacle not existing on the “predefined map” detected by the differential obstacle detector 106.

The “corrected approach area” generated by the approach area corrector 107 is output to the environment map integrator 108.

The environment map integrator 108 creates an “integrated environment map” by using the following input information:
(a) the “predefined map” from the predefined map manager 105;
(b) the “obstacle map” from the obstacle map creator 103; and
(c) “corrected approach area information” and “differential obstacle information” from the approach area corrector 107.

The environment map integrator 108 creates an “integrated environment map” by using the above input information.

That is, the environment map integrator 108 creates the “integrated environment map” in which the latest location of the obstacle and the “corrected approach area” obtained by correcting the “preset approach area” recorded in the “predefined map” on the basis of the latest location of the obstacle are recorded.

As described above with reference to FIG. 5, the “corrected approach area” is recorded in the “integrated environment map”. The “corrected approach area” is an area defined as a work area where the robot 10 can execute scheduled work without contacting an existing obstacle or the differential obstacle (new obstacle).

The work sequence by the robot using the “integrated environment map” reflecting the corrected approach area generated by the approach area corrector 107 of the information processing device 100 of the robot 10 will be described.

As described above with reference to FIG. 3, the sequence control unit 114 of the information processing device 100 attached to the robot 10 moves the moving unit 11, the arm 12, and the hand 13 of the robot 10 on the basis of the work sequence in the work definition data generated in the user terminal 30, manages the progress of the movement, and performs sequence control.

In accordance with the motion start instruction from the robot control unit 113, the sequence control unit 114 instructs the moving body path planner 121 and the robot arm path planner 123 to perform a motion of the moving body and the robot arm on the basis of the work sequence received from the work definition data manager 104.

The moving unit path planner 121 moves the moving unit 11 of the robot 10 to an instructed location in accordance with an instruction from the sequence control unit 114.

The following instruction is mainly input from the sequence control unit 114 to the moving body path planner 121.
Instruction to move to via-point
Instruction to move to approach area of work target

In response to these instructions, the moving body path planner 121 generates a path for achieving the instructed motion by using the “integrated environment map” generated by the environment map integrator 108.

On the basis of the “integrated environment map” generated by the environment map integrator 108 and the self-location estimated by the self-location estimator 102, the moving unit path planner 121 generates path information (travel route information) that allows traveling of a via-point on a movement path of the robot 10 instructed by the sequence control unit 114 and an approach area that is a work allowable area at each work location while avoiding obstacles, and outputs the generated path information to a moving body control unit 122.

Note that, in movement plan generation processing from the current location to the via-point executed by the moving unit path planner 121, for example, an A-star (A*) or a rapidly-exploring random tree (RRT), which is an existing method of movement path generation, can be used.

A specific example of generation processing of the movement path to the approach area executed by the moving unit path planner 121 will be described.

Note that in a case where there is a corrected approach area obtained by correcting the preset approach area, the moving unit path planner 121 performs the generation processing of the movement path to the corrected approach area. In a case where there is no corrected approach area obtained by correcting the preset approach area, a generation processing of the movement path to the preset approach area is performed.

The moving unit path planner 121 first selects a candidate of an approach location from within the approach area (the corrected approach area or the preset approach area).

Since it has been confirmed that the work can be performed on the work target without interference (contact) with the obstacle anywhere in the approach area, there is no problem in selecting anywhere in the approach area.

For example, in consideration of an error in the movement location caused by a control error during movement, an error in self-location estimation, or the like, it is better to adopt a point near the center inside the approach area. Specifically, the approach area may be divided into combinations of convex polygons such as triangles, and a point farthest from the outer periphery may be adopted among the centers (centroids) of the divided convex polygons.

In addition, an approach location having the shortest path may be selected in consideration of the next work and target location in the work sequence.

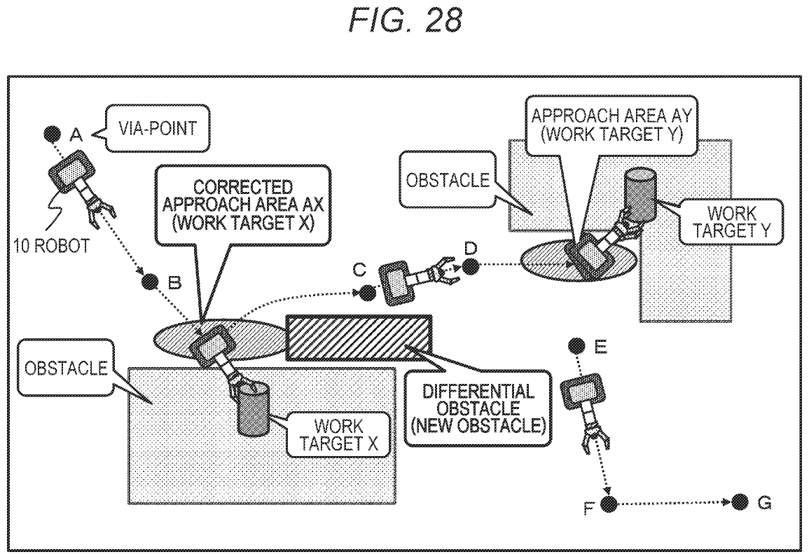

For example, a motion example of the robot 10 in a case where the work according to the work sequence illustrated in FIG. 9 described above is executed will be described with reference to FIG. 28.

As illustrated in FIG. 28, after starting the via-point A, the robot 10 moves to the via-point B, works on the work target X, and moves to the via-point C in that order.

The approach location for working on the work target X is denoted by AX.

In this case, the moving unit path planner 121 determines the approach location AX that minimizes a moving distance from the via-point B to the via-point C. That is, the approach location AX in the approach area where the following distance is the shortest is calculated:

moving distance from via-point B to via-point C=distance(B−AX)+distance(AX−C).

When the location of the approach location AX is determined, a path passing through the point AX, that is, a path connecting the following points is generated: the via-point B, the approach location AX, and the via-point C.

As a method of generating a path, for example, the A-star (A*) or RRT can be used similarly to the movement to the via-point.

In addition, in a case where the periphery of the approach location selected as a selection candidate by the moving unit path planner 121 is narrow and the determination of the approach location fails, another approach location candidate is selected and the path generation is attempted again.

As another method of selecting a candidate location of the approach location, for example, it is possible to apply an algorithm such as changing to a candidate of the next point (for example, a point having the second shortest moving distance to the preceding and following via-points) at the time of selecting a candidate of the approach location, randomly selecting a point from inside the approach area, or using a point separated from the candidate of the current approach location by a certain distance.

Furthermore, the timing at which the moving body path planner 121 generates a path may be not only the timing at which a motion instruction is received from the sequence control unit 114 but also the timing at which a moving instruction described in the work sequence is generated in advance.

In addition, the path may be generated at the timing at which the integrated environment map is updated by the environment map integrator 108 or at the timing at which a new differential obstacle is detected by the differential obstacle detector 106 and the integrated environment map reflecting the differential obstacle is generated by the environment map integrator 108.

When the moving body path planner 121 generates a path, the path is passed to the moving body control unit 122.

The moving body control unit 122 controls the moving unit 11 of the robot to move the robot 10 in accordance with the path information (travel route information) on the basis of the path information (travel route information) generated by the moving body path planner 121 and the self-location of the robot 10 estimated by the self-location estimator 102. That is, the robot is caused to travel so as to follow the path of the path information (travel route information) generated by the moving body path planner 121.

As a path following control algorithm, for example, Pure Pursuit can be used.

In accordance with an instruction from the sequence control unit 114, the robot arm path planner 123 plans a path (trajectory) of the arm 12 and the hand 13 of the robot 10 for performing the instructed work, that is, a work set by the work definition data, and outputs the generated path (trajectory) to the robot arm control unit 124.

Furthermore, the robot arm path planner 123 may more precisely measure the location of the work target by using imaging information of the camera constituting the sensor 101 mounted on the robot 10, correct the target location on the basis of the measurement result, and correct the trajectory together.

The trajectory of the robot arm generated by the robot arm path planner 123 is passed to the robot arm control unit 124, and the robot arm control unit 124 controls the robot arm so as to follow the generated trajectory.

That is, the robot arm control unit 124 drives a drive unit of joints and the like of the arm and the hand 13 of the robot 10 so that the arm 12 and the hand 13 of the robot 10 move by using the path (trajectory) of the arm 12 and the hand 13 of the robot 10 generated by the robot arm path planner 123. For example, a motor driver of joints and the like of the arm and the hand 13 of the robot 10 is controlled.

As described above, in robot control processing of the present disclosure, the “preset approach area” in which the robot 10 does not contact the obstacle when performing work on the work target object and the “predefined map” that records the obstacle information are generated.

Next, a differential obstacle not existing on the “predefined map” is detected on the basis of a sensing result obtained while the robot 10 is traveling.

Furthermore, as correction processing of the “preset approach area”, interference (contact) with a differential obstacle is confirmed, and a “corrected approach area” in which an area where interference (contact) occurs is deleted is generated.

When the “corrected approach area” is generated, the sampling point is set only in the “preset approach area”, and the determination processing is performed. By performing this processing, when the number of obstacles increases after the creation of the work definition data, the approach area can be corrected without greatly increasing a calculation amount, and the possibility that the work of the robot stops due to a calculation delay can be reduced.

Note that the robot 10 of the present disclosure is not limited to a robot that travels on the ground with a moving mechanism such as wheels described in the embodiment. For example, the robot 10 may move on water or in the air. Note that the approach area can also be set as an area having a three-dimensional spread, and in this case, the approach area space is expressed by using three-dimensional representation (for example, a Voxel Map or the like).

### 8. Hardware Configuration Example of Information Processing Device of Present Disclosure

Next, an example of a hardware configuration of the information processing device of the present disclosure will be described.

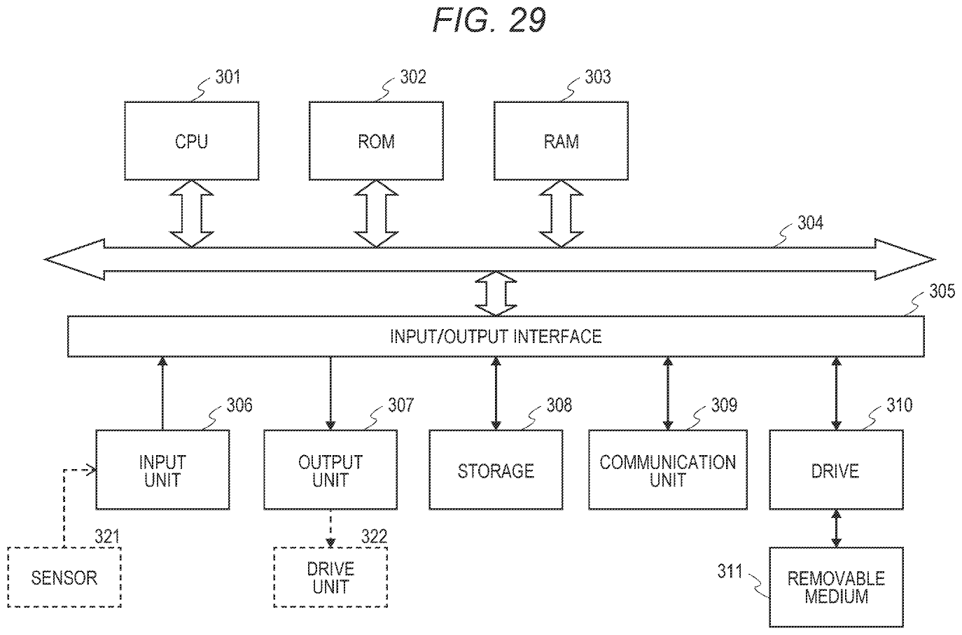

An example of the hardware configuration of the information processing device of the present disclosure will be described with reference to FIG. 29.

Note that the hardware configuration of the information processing device illustrated in FIG. 29 is a configuration example of a hardware configuration of the information processing device 100 attached to the robot 10. Furthermore, it is also a configuration example of a hardware configuration of the user terminal 30.

A central processing unit (CPU) 301 functions as a data processing unit that performs various types of processing in accordance with a program stored in a read only memory (ROM) 302 or a storage 308. For example, processing according to the sequences described in the embodiment described above is performed. A random access memory (RAM) 303 stores programs, data, and the like to be performed by the CPU 301. The CPU 301, the ROM 302, and the RAM 303 are connected to each other by a bus 304.

The CPU 301 is connected to an input/output interface 305 via the bus 304, and the input/output interface 305 is connected with an input unit 306 including various switches, a keyboard, a touch panel, a mouse, a microphone, a user input unit, and the like, and an output unit 307 including a display, a speaker, and the like.

Note that, in the case of the information processing device 100 attached to the robot 10, sensor detection information from various sensors 321 such as a camera and a LiDAR is also input to the input unit 306.

Furthermore, in the case of the information processing device 100 attached to the robot 10, the output unit 307 also outputs drive information for a drive unit 322 that drives the robot or the like.

The CPU 301 inputs commands, status data, and the like input from the input unit 306, executes various types of processing, and outputs processing results to, for example, the output unit 307.

The storage 308 connected to the input/output interface 305 includes, for example, a flash memory, a hard disk, or the like, and stores a program executed by the CPU 301 or various types of data. A communication unit 309 functions as a transmitter and receiver for data communication via a network such as the Internet or a local area network, and communicates with an external device.

Furthermore, in addition to the CPU, a graphics processing unit (GPU) may be provided as a dedicated processing unit for image information and the like input from the camera.

A drive 310 connected to the input/output interface 305 drives a removable medium 311 such as a magnetic disk, an optical disk, a magneto-optical disk, or a semiconductor memory such as a memory card, and records or reads data.

### 9. Summary of Configuration of Present Disclosure

The embodiment of the present disclosure has been described above in detail with reference to specific embodiments. However, it is obvious that those skilled in the art can modify or substitute the embodiments without departing from the gist of the present disclosure. That is, the present invention has been disclosed in the form of exemplification, and should not be interpreted in a limited manner. In order to determine the gist of the present disclosure, the claims should be considered.

Note that the technology herein disclosed can have the following configurations.
(1) An information processing device includes
   a differential obstacle detector that detects a differential obstacle corresponding to a difference from an obstacle recorded on a predefined map on the basis of information from a sensor that acquires travel environment information of a robot, and
   an approach area corrector that corrects, in consideration of the differential obstacle, a preset approach area in which a work by the robot is determined to be executable without contact with the obstacle, and generates a corrected approach area, the preset approach area including an area recorded on the predefined map, in which
   the approach area corrector determines whether or not a sampling point set inside the preset approach area allows the robot to work without contacting the differential obstacle, and generates the corrected approach area.
(2) In the information processing device according to (1),
   the approach area corrector sets no sampling point outside the preset approach area, and
   the approach area corrector executes processing of determining whether or not the sampling point set inside the preset approach area allows the robot to work without contacting the differential obstacle, and generates the corrected approach area.
(3) In the information processing device according to (1) or (2),
   the approach area corrector determines on only the sampling point set inside the preset approach area whether or not the sampling point set inside the preset approach area allows the robot to work without contacting the differential obstacle, and
   the approach area corrector sets an area including only the sampling point determined to be workable without the robot contacting the differential obstacle as the corrected approach area.
(4) In the information processing device according to (3),
   the approach area corrector determines whether or not each of the sampling points set inside the preset approach area allows the robot to perform a preset work motion on a preset work target object without contacting the differential obstacle.
(5) In the information processing device according to any of (1) to (4), the predefined map includes a map created before the robot starts traveling.
(6) In the information processing device according to any of (1) to (5), the predefined map includes a map input from an external device to the information processing device.
(7) The information processing device according to any of (1) to (6) further includes
   a work definition data manager that manages work definition data including the predefined map, in which
   the approach area corrector
   inputs the predefined map from the work definition data manager,
   inputs, from the differential obstacle detector, differential obstacle information that is information regarding a new obstacle that does not exist on the predefined map, and
   generates the corrected approach area.
(8) The information processing device according to any of (1) to (7) further includes
   a work definition data manager that manages work definition data including the predefined map, in which
   the work definition data manager manages the work definition data including each data of
   (a) the predefined map,
   (b) work sequence information, and
   (c) work motion information.
(9) The information processing device according to (8) further includes
   a sequence control unit that controls a motion sequence of the robot, in which
   the sequence control unit controls a work sequence of the robot in accordance with the work sequence information input from the work definition data manager.
(10) The information processing device according to any of (1) to (9) further includes
   an environment map integrator that generates an integrated environment map in which the corrected approach area generated by the approach area corrector is recorded.
(11) In the information processing device according to (10), the environment map integrator inputs the predefined map and the corrected approach area generated by the approach area corrector, and generates the integrated environment map in which the corrected approach area is recorded.
(12) The information processing device according to any of (1) to (11) further includes
   an environment map integrator that generates an integrated environment map in which the corrected approach area generated by the approach area corrector is recorded, and
   a path planner that plans a movement path of the robot by using the integrated environment map generated by the environment map integrator.
(13) In the information processing device according to any of (1) to (12),
   the approach area corrector executes processing of generating a re-corrected approach area obtained by correcting again a generated corrected approach area generated in approach area correction processing executed in a past in consideration of a differential obstacle that has newly occurred, and
   the approach area corrector determines whether or not a sampling point set inside the generated corrected approach area allows the robot to work without contacting the differential obstacle that has newly occurred, and generates the re-corrected approach area.
(14) An information processing system includes a user terminal, and an information processing device attached to a robot, in which
   the user terminal generates a predefined map including a location of an obstacle in a travel environment of the robot and a preset approach area in which a work by the robot is determined to be executable without contact with the obstacle, and inputs the predefined map to the information processing device attached to the robot,
   the information processing device attached to the robot includes
   a differential obstacle detector that detects a differential obstacle corresponding to a difference from the obstacle recorded in the predefined map input from the user terminal on the basis of information from a sensor that acquires travel environment information of the robot, and
   an approach area corrector that corrects, in consideration of the differential obstacle, a preset approach area in which a work by the robot is determined to be executable without contact with the obstacle, and generates a corrected approach area, the preset approach area including an area recorded in the predefined map, and
   the approach area corrector determines whether or not a sampling point set inside the preset approach area allows the robot to work without contacting the differential obstacle, and generates the corrected approach area.
(15) In the information processing system according to (14), the user terminal inputs work definition data having each data of
   (a) the predefined map,
   (b) the work sequence information, and
   (c) the work motion information
   to the information processing device of the robot, and the information processing device of the robot executes
   processing of generating the corrected approach area by using the work definition data including the each data,
   processing of generating an integrated environment map reflecting the corrected approach area, and processing of controlling the robot with reference to the integrated environment map.
(16) In the information processing system according to (14) or (15),
   in the processing of generating the corrected approach area,
   the information processing device of the robot sets no sampling point outside the preset approach area, and
   the information processing device executes processing of determining whether or not the sampling point set inside the preset approach area allows the robot to work without contacting the differential obstacle, and generates the corrected approach area.
(17) An information processing method executed in an information processing device, includes
   a differential obstacle detecting step of detecting, by a differential obstacle detector, a differential obstacle corresponding to a difference from an obstacle recorded on a predefined map on the basis of information from a sensor that acquires travel environment information of a robot, and
   an approach area correcting step of correcting, by an approach area corrector, in consideration of the differential obstacle, a preset approach area in which a work by the robot is determined to be executable without contact with the obstacle, and generating a corrected approach area, the preset approach area including an area recorded in the predefined map, in which
   the approach area correcting step includes determining whether or not a sampling point set inside the preset approach area allows the robot to work without contacting the differential obstacle, and generating the corrected approach area.
(18) An information processing method executed in an information processing system including a user terminal and an information processing device attached to a robot, includes
   generating, by the user terminal, a predefined map including a location of an obstacle in a travel environment of the robot and a preset approach area in which a work by the robot is determined to be executable without contact with the obstacle, and inputting the predefined map to the information processing device attached to the robot, and
   executing, by the information processing device attached to the robot,
   differential obstacle detecting processing of detecting a differential obstacle corresponding to a difference from the obstacle recorded in the predefined map input from the user terminal on the basis of information from a sensor that acquires travel environment information of the robot, and
   approach area correction processing of correcting, in consideration of the differential obstacle, a preset approach area in which the work by the robot is determined to be executable without contact with the obstacle, and generating a corrected approach area, the preset approach area including an area recorded in the predefined map, in which
   the approach area correction processing includes determining whether or not a sampling point set inside the preset approach area allows the robot to work without contacting the differential obstacle, and generating the corrected approach area.
(19) A program that causes an information processing device to execute information processing, the information processing including
   a differential obstacle detecting step of causing a differential obstacle detector to detect a differential obstacle corresponding to a difference from an obstacle recorded on a predefined map on the basis of information from a sensor that acquires travel environment information of a robot, and
   an approach area correcting step of causing an approach area corrector to correct, in consideration of the differential obstacle, a preset approach area in which a work by the robot is determined to be executable without contact with the obstacle, and generate a corrected approach area, the preset approach area including an area recorded in the predefined map, in which
   the approach area correcting step includes determining whether or not a sampling point set inside the preset approach area allows the robot to work without contacting the differential obstacle, and generating the corrected approach area.

Note that a series of processing herein described can be executed by hardware, software, or a combined configuration of the both. In a case where processing by software is executed, a program in which a processing sequence is recorded can be installed and executed in a memory in a computer incorporated in dedicated hardware, or the program can be installed and executed in a general-purpose computer capable of executing various types of processing. For example, the program can be recorded in advance in a recording medium. In addition to being installed on a computer from the recording medium, a program can be received via a network such as a local area network (LAN) or the Internet and installed on a recording medium such as an internal hard disk or the like.

Furthermore, the various types of processing herein described may be performed not only in time series as described, but also in parallel or individually in accordance with the processing capability of the device that performs the processing or as necessary. Furthermore, a system herein described is a logical set configuration of a plurality of devices, and is not limited to a system in which devices of respective configurations are in the same housing.

### INDUSTRIAL APPLICABILITY

As described above, the configuration according to an embodiment of the present disclosure can achieve a device and a method that can quickly correct an approach area defined as a work area of a robot when a new obstacle that is not on a predefined map occurs.

Specifically, for example, there are provided a differential obstacle detector that detects a differential obstacle corresponding to a difference from an obstacle recorded on a predefined map on the basis of information from a sensor that acquires travel environment information of the robot, and an approach area corrector that corrects, in consideration of the differential obstacle, a preset approach area in which a work by the robot is determined to be executable without contact with the obstacle, and generates a corrected approach area, the preset approach area including an area recorded on the predefined map. The approach area corrector determines whether or not a sampling point set inside the preset approach area allows the robot to work without contacting the differential obstacle, and generates the corrected approach area.

This configuration can achieve a device and a method that can quickly correct the approach area defined as the work area of the robot when a new obstacle that is not on the predefined map occurs.

### REFERENCE SIGNS LIST

10 Robot
11 Moving unit
12 Arm
13 Hand
20 User
30 User terminal
100 Information processing device
101 Sensor
102 Self-location estimator
103 Obstacle map creator
104 Work definition data manager
105 Predefined map manager
106 Differential obstacle detector
107 Approach area corrector
108 Environment map integrator
111 Communication IIF
112 Robot operation UI
113 Robot control unit
114 Sequence control unit
121 Moving unit path planner
122 Moving unit control unit
123 Robot arm path planner
124 Robot arm control unit
200 User terminal
201 User interface (UI)
202 User interface (UI) control unit
203 Robot operation information manager
204 Work definition data manager
205 Approach area generator
206 Predefined map generator
207 Work definition data storage
208 Communication IF
301 CPU
302 ROM
303 RAM
304 Bus
305 Input/output interface
306 Input unit
307 Output unit
308 Storage
309 Communication unit
310 Drive
311 Removable medium
321 Sensor
322 Drive unit

1. An information processing device comprising:
a differential obstacle detector that detects a differential obstacle corresponding to a difference from an obstacle recorded on a predefined map on a basis of information from a sensor that acquires travel environment information of a robot; and
an approach area corrector that corrects, in consideration of the differential obstacle, a preset approach area in which a work by the robot is determined to be executable without contact with the obstacle, and generates a corrected approach area, the preset approach area including an area recorded on the predefined map, wherein
the approach area corrector determines whether or not a sampling point set inside the preset approach area allows the robot to work without contacting the differential obstacle, and generates the corrected approach area.

2. The information processing device according to claim 1, wherein
the approach area corrector sets no sampling point outside the preset approach area, and
the approach area corrector executes processing of determining whether or not the sampling point set inside the preset approach area allows the robot to work without contacting the differential obstacle, and generates the corrected approach area.

3. The information processing device according to claim 1, wherein
the approach area corrector determines on only the sampling point set inside the preset approach area whether or not the sampling point set inside the preset approach area allows the robot to work without contacting the differential obstacle, and
the approach area corrector sets an area including only the sampling point determined to be workable without the robot contacting the differential obstacle as the corrected approach area.

4. The information processing device according to claim 3, wherein
the approach area corrector determines whether or not each of the sampling points set inside the preset approach area allows the robot to perform a preset work motion on a preset work target object without contacting the differential obstacle.

5. The information processing device according to claim 1, wherein
the predefined map includes a map created before the robot starts traveling.

6. The information processing device according to claim 1, wherein
the predefined map includes a map input from an external device to the information processing device.

7. The information processing device according to claim 1, further comprising
a work definition data manager that manages work definition data including the predefined map, wherein
the approach area corrector
inputs the predefined map from the work definition data manager,
inputs, from the differential obstacle detector, differential obstacle information that is information regarding a new obstacle that does not exist on the predefined map, and
generates the corrected approach area.

8. The information processing device according to claim 1, further comprising
a work definition data manager that manages work definition data including the predefined map, wherein
the work definition data manager manages the work definition data including each data of
(a) the predefined map,
(b) work sequence information, and
(c) work motion information.

9. The information processing device according to claim 8, further comprising
a sequence control unit that controls a motion sequence of the robot, wherein
the sequence control unit controls a work sequence of the robot in accordance with the work sequence information input from the work definition data manager.

10. The information processing device according to claim 1, further comprising
an environment map integrator that generates an integrated environment map in which the corrected approach area generated by the approach area corrector is recorded.

11. The information processing device according to claim 10, wherein
the environment map integrator inputs the predefined map and the corrected approach area generated by the approach area corrector, and generates the integrated environment map in which the corrected approach area is recorded.

12. The information processing device according to claim 1, further comprising:
an environment map integrator that generates an integrated environment map in which the corrected approach area generated by the approach area corrector is recorded; and
a path planner that plans a movement path of the robot by using the integrated environment map generated by the environment map integrator.

13. The information processing device according to claim 1, wherein
the approach area corrector executes processing of generating a re-corrected approach area obtained by correcting again a generated corrected approach area generated in approach area correction processing executed in a past in consideration of a differential obstacle that has newly occurred, and
the approach area corrector determines whether or not a sampling point set inside the generated corrected approach area allows the robot to work without contacting the differential obstacle that has newly occurred, and generates the re-corrected approach area.

14. An information processing system comprising: a user terminal; and an information processing device attached to a robot, wherein
the user terminal generates a predefined map including a location of an obstacle in a travel environment of the robot and a preset approach area in which a work by the robot is determined to be executable without contact with the obstacle, and inputs the predefined map to the information processing device attached to the robot,
the information processing device attached to the robot includes
a differential obstacle detector that detects a differential obstacle corresponding to a difference from the obstacle recorded in the predefined map input from the user terminal on a basis of information from a sensor that acquires travel environment information of the robot, and
an approach area corrector that corrects, in consideration of the differential obstacle, a preset approach area in which the work by the robot is determined to be executable without contact with the obstacle, and generates a corrected approach area, the preset approach area including an area recorded in the predefined map, and
the approach area corrector determines whether or not a sampling point set inside the preset approach area allows the robot to work without contacting the differential obstacle, and generates the corrected approach area.

15. The information processing system according to claim 14, wherein
the user terminal inputs work definition data having each data of
(a) the predefined map,
(b) the work sequence information, and
(c) the work motion information
to the information processing device of the robot, and
the information processing device of the robot executes processing of generating the corrected approach area by using the work definition data including the each data,
processing of generating an integrated environment map reflecting the corrected approach area, and
processing of controlling the robot with reference to the integrated environment map.

16. The information processing system according to claim 14, wherein
in the processing of generating the corrected approach area,
the information processing device of the robot sets no sampling point outside the preset approach area, and
the information processing device executes processing of determining whether or not the sampling point set inside the preset approach area allows the robot to work without contacting the differential obstacle, and generates the corrected approach area.

17. An information processing method executed in an information processing device, the method comprising:
a differential obstacle detecting step of detecting, by a differential obstacle detector, a differential obstacle corresponding to a difference from an obstacle recorded on a predefined map on a basis of information from a sensor that acquires travel environment information of a robot; and
an approach area correcting step of correcting, by an approach area corrector, in consideration of the differential obstacle, a preset approach area in which a work by the robot is determined to be executable without contact with the obstacle, and generating a corrected approach area, the preset approach area including an area recorded in the predefined map, wherein
the approach area correcting step includes determining whether or not a sampling point set inside the preset approach area allows the robot to work without contacting the differential obstacle, and generating the corrected approach area.

18. An information processing method executed in an information processing system including a user terminal and an information processing device attached to a robot, the method comprising:
generating, by the user terminal, a predefined map including a location of an obstacle in a travel environment of the robot and a preset approach area in which a work by the robot is determined to be executable without contact with the obstacle, and inputting the predefined map to the information processing device attached to the robot; and
executing, by the information processing device attached to the robot,
differential obstacle detecting processing of detecting a differential obstacle corresponding to a difference from the obstacle recorded in the predefined map input from the user terminal on a basis of information from a sensor that acquires travel environment information of the robot, and
approach area correction processing of correcting, in consideration of the differential obstacle, a preset approach area in which the work by the robot is determined to be executable without contact with the obstacle, and generating a corrected approach area, the preset approach area including an area recorded in the predefined map, wherein
the approach area correction processing includes determining whether or not a sampling point set inside the preset approach area allows the robot to work without contacting the differential obstacle, and generating the corrected approach area.

19. A program that causes an information processing device to execute information processing, the information processing including
a differential obstacle detecting step of causing a differential obstacle detector to detect a differential obstacle corresponding to a difference from an obstacle recorded on a predefined map on a basis of information from a sensor that acquires travel environment information of a robot, and
an approach area correcting step of causing an approach area corrector to correct, in consideration of the differential obstacle, a preset approach area in which a work by the robot is determined to be executable without contact with the obstacle, and generate a corrected approach area, the preset approach area including an area recorded in the predefined map, wherein
the approach area correcting step includes determining whether or not a sampling point set inside the preset approach area allows the robot to work without contacting the differential obstacle, and generating the corrected approach area.
